(19) United States
(12) Patent Application Publication
(10) Pub. No.: US 2023/0074610 A1
(43) Pub. Date: Mar. 9, 2023

(54) SECONDARY BATTERY, FORMATION METHOD THEREOF, AND VEHICLE

(71) Applicant: SEMICONDUCTOR ENERGY LABORATORY CO., LTD., Atsugi-shi, Kanagawa-ken (JP)

(72) Inventors: Teruaki OCHIAI, Atsugi, Kanagawa (JP); Yumiko YONEDA, Isehara, Kanagawa (JP); Kazutaka KURIKI, Ebina, Kanagawa (JP); Shunpei YAMAZAKI, Setagaya, Tokyo (JP)

(21) Appl. No.: 17/904,395

(22) PCT Filed: Mar. 2, 2021
(86) PCT No.: PCT/IB2021/051706

§ 371 Date: Aug. 17, 2022

(30) Foreign Application Priority Data
Mar. 13, 2020 (JP) 2020-044521

(51) Int. Cl. H01M 4/62; H01M 4/04; H01M 10/0525; H01M 4/38; B60L 50/64

(52) U.S. Cl. CPC H01M 4/625; H01M 4/0404; H01M 4/043; H01M 4/623; H01M 10/0525; H01M 4/388; B60L 50/64; H01M 2004/028

(57) ABSTRACT

An active material layer that has a high filling rate and a higher density and is formed using a small amount of conductive additive is provided. A positive electrode active material layer includes a first carbon material and a second carbon material, which is more likely to aggregate than the first carbon material, and mixing is performed such that the weight of the second carbon material is more than or equal to 1.5 times and less than or equal to 20 times that of the first carbon material, thereby preventing the aggregation of the second carbon material and the aggregation of the first carbon material and reducing the proportion of the aggregated portions.

### TECHNICAL FIELD

The present invention relates to an object, a method, or a manufacturing method. Alternatively, the present invention relates to a process, a machine, manufacture, or a composition of matter. In particular, one embodiment of the present invention relates to a semiconductor device, a display device, a light-emitting device, a secondary battery, a power storage device, a memory device, a driving method thereof, or a manufacturing method thereof. In particular, one embodiment of the present invention relates to a secondary battery, a power storage device, and a manufacturing method thereof. One embodiment of the present invention relates to a vehicle including a secondary battery or an electronic device for vehicles provided in a vehicle.

Note that in this specification, a secondary battery or a power storage device refers to every element and device having a function of storing power.

### BACKGROUND ART

In recent years, a variety of power storage devices such as lithium-ion secondary batteries, lithium-ion capacitors, air batteries, and all-solid-state batteries have been actively developed. In particular, demand for lithium-ion secondary batteries with high output and high energy density has rapidly grown with the development of the semiconductor industry, for portable information terminals such as mobile phones, smartphones, tablets, and notebook computers; portable music players; digital cameras; medical equipment; drones; next-generation clean energy vehicles such as hybrid electric vehicles (HVs), electric vehicles (EVs), and plug-in hybrid electric vehicles (PHVs); and the like. The lithium-ion secondary batteries are essential as rechargeable energy supply sources for today's information society.

Electric vehicles (EVs) are vehicles in which only an electric motor is used for a driving portion, and there are also hybrid electric vehicles having both an internal-combustion engine such as an engine and an electric motor. A plurality of secondary batteries used in vehicles are provided as a battery pack, and a plurality of battery packs are provided on the lower portion of a vehicle.

Electronic devices carried around by users or electronic devices worn by users operate using primary batteries or secondary batteries, which are examples of a power storage device, as power sources. It is desired that electronic devices carried around by users be used for a long time; thus, a high-capacity secondary battery is used. Since high-capacity secondary batteries are large in size, there is a problem in that their incorporation in electronic devices increases the weight of the electronic devices. In view of the problem, development of small or thin high-capacity secondary batteries that can be incorporated in portable electronic devices is being pursued.

As described above, lithium-ion secondary batteries have been used for a variety of purposes in various fields. The performance required for lithium-ion secondary batteries includes high energy density, excellent cycle performance, and safety in a variety of operation environments.

In particular, lithium-cobalt composite oxides (LiCoO₂), which allow a voltage as high as 4 V, are widely available as positive electrode active materials of secondary batteries. As a conductive additive, carbon black is widely used. Patent Document 1 discloses a positive electrode for a nonaqueous secondary battery using graphene oxide to form an active material layer having high electron conductivity with a small amount of conductive additive. Patent Document 2 discloses a method for forming an electrode for a storage battery using graphene oxide and acetylene black.

### REFERENCES

### Patent Documents

[Patent Document 1] Japanese Published Patent Application No. 2014-7141
[Patent Document 1] Japanese Published Patent Application No. 2017-63032

### SUMMARY OF THE INVENTION

### Problems to be Solved by the Invention

A secondary battery includes at least an exterior body, a current collector, an active material (a positive electrode active material or a negative electrode active material), a conductive additive, and a binder. An electrolyte solution in which a lithium salt or the like is dissolved is also included. In the case of a solid-state battery, a solid electrolyte is included.

A current collector is metal foil, and an electrode is formed by applying a slurry onto the metal foil and performing drying. Pressing may be performed after drying. The electrode is a component obtained by forming an active material layer over the current collector.

A slurry refers to a material solution that is used to form an active material layer over a current collector and includes at least an active material particle, a binder, and a solvent, preferably also a conductive additive mixed therewith. A slurry may also be referred to as an electrode slurry or an active material slurry; in some cases, a slurry for a positive electrode is used for forming a positive electrode active material layer, and a slurry for a negative electrode is used for forming a negative electrode active material layer.

A conductive additive is also referred to as a conductivity-imparting agent and a conductive material, and a carbon material is used. A conductive additive is attached between a plurality of active material particles, whereby the plurality of active material particles are electrically connected to each other, and the conductivity increases. Note that the term “attach” refers not only to a state where an active material particle and a conductive additive are physically in close contact with each other, and includes, for example, the following concepts: the case where covalent bonding occurs, the case where bonding with the Van der Waals force occurs, the case where a conductive additive covers part of the surface of an active material particle, the case where a conductive additive is embedded in surface roughness of an active material particle, and the case where an active material particle and a conductive additive are electrically connected to each other without being in contact with each other.

Typical examples of a carbon material used as a conductive additive include carbon black (e.g., furnace black, acetylene black, and graphite). Carbon black refers to bulky particles with an average particle diameter of several tens of nanometers to several hundreds of nanometers; thus, the contact between carbon black and another material hardly becomes surface contact and tends to be point contact. Hence, in the case where an active material and carbon black are mixed, the contact resistance between the active material and the carbon black is high. Using a large amount of carbon black in order to decrease the contact resistance lowers the proportion of the active material in the whole electrode, thereby reducing the discharge capacity of a secondary battery.

In addition, carbon black is a material that is likely to aggregate and thus is difficult to mix to be uniformly dispersed.

As a carbon material used as a conductive additive, a single layer or a stacked layer of graphene is known. Graphene, which has electrically, mechanically, or chemically marvelous characteristics, is a carbon material that is expected to be used in a variety of fields, such as field-effect transistors or solar batteries. However, it is known that graphene is unlikely to be dispersed. Graphene needs to be dispersed so that graphene can be used as a conductive additive. Since graphene has a large specific surface area, graphene is difficult to disperse and might be aggregated. When aggregated graphene is used as a conductive additive, graphene has a difficulty in sufficiently functioning as the conductive additive.

In a positive electrode of a secondary battery, a binder (a resin) is mixed in order to fix a current collector such as metal foil and an active material. The binder is also referred to as a binding agent. Since the binder is a high-molecular material, a large amount of binder lowers the proportion of the active material in the positive electrode, thereby reducing the discharge capacity of the secondary battery. Therefore, the amount of binder is reduced to a minimum.

An object is to provide an active material layer that has a high filling rate and a higher density and is formed using a small amount of conductive additive. That is, an object of one embodiment of the present invention is to provide a method for forming a novel electrode slurry.

Another object of one embodiment of the present invention is to provide a method for forming a novel positive electrode. Another object is to increase the density of an active material layer to increase capacity. Another object is to improve the rate performance of a secondary battery. Another object is to improve the energy density of a secondary battery. Another object is to improve the cycle performance of a secondary battery. Another object of one embodiment of the present invention is to provide a novel positive electrode.

Another object of one embodiment of the present invention is to provide a novel secondary battery, a novel electronic device, and the like. Another object of one embodiment of the present invention is to provide a method for forming a novel secondary battery.

Another object is to provide a vehicle including a secondary battery and having a high mileage, specifically, a driving range per charge of 500 km or longer.

Note that the description of these objects does not preclude the existence of other objects. One embodiment of the present invention does not have to achieve all these objects. Other objects can be derived from the description of the specification, the drawings, and the claims.

### Means for Solving the Problems

A positive electrode active material layer includes a first carbon material and a second carbon material, which is more likely to aggregate than the first carbon material, and mixing is performed such that the weight of the second carbon material is more than or equal to 1.5 times and less than or equal to 20 times, preferably more than or equal to 2 times and less than or equal to 9.5 times that of the first carbon material, thereby preventing the aggregation of the second carbon material and the aggregation of the first carbon material and reducing the proportion of the aggregated portions. The feasibility of aggregation, that is, the degree of aggregation, is determined with an apparent state in cross-sectional observation.

The first carbon material is graphene also referred to as single-layer graphene or multilayer graphene, the second carbon material is carbon black, and both of them function as conductive additives (also referred to as conductivity-imparting agents or conductive materials). Graphene and carbon black are mixed to be used as conductive additives of an electrode, so that uniformity can be increased and a highly conductive network can be formed in the electrode. Graphene has a thin surface shape and thus can efficiently form a conductive path with a smaller amount than another conductive additive, thereby increasing the proportion of an active material and improving the capacity per volume of the electrode. This enables a secondary battery to have a smaller size and higher capacity. In addition, the use of graphene can inhibit a capacity decrease due to fast charging and discharging.

A method disclosed in this specification is a method for forming a secondary battery, including a first step of mixing graphene, carbon black, and a binder to obtain a first mixture; a second step of mixing the first mixture with a positive electrode active material to obtain a second mixture; a third step of mixing the second mixture with a dispersion medium to obtain an electrode slurry; a fourth step of applying the electrode slurry to a positive electrode current collector; a fifth step of drying the electrode slurry to form a positive electrode; and a sixth step of overlapping the positive electrode and a negative electrode to form a secondary battery. A weight of the carbon black is more than or equal to 1.5 times and less than or equal to 20 times, preferably more than or equal to 2 times and less than or equal to 9.5 times a weight of the graphene in the mixing in the first step.

In the above structure, pressing is further performed after the fifth step at a press line pressure of higher than or equal to 700 kN/m to obtain a high-density positive electrode. Specifically, the density of the positive electrode active material layer measured by gravimetry can be higher than 3.5 g/cc. Increasing the electrode density can increase the filling rate in the battery pack and thus can increase the energy density per volume.

The positive electrode active material layer obtained by the above method has the following features, and a secondary battery including at least a positive electrode formed using the positive electrode active material layer can have an increased capacity.

When graphene and carbon black are mixed in the above range, carbon black is excellent in dispersion stability and an aggregated portion is unlikely to be generated at the time of preparing a slurry.

A secondary battery formed by the above formation method is one of the structures of the present invention, which includes a positive electrode active material particle containing lithium and cobalt, a positive electrode active material layer including a first carbon material, a second carbon material, and a resin, and a negative electrode active material layer overlapping with the positive electrode active material layer. A weight of the second carbon material is more than or equal to 1.5 times and less than or equal to 20 times, preferably more than or equal to 2 times and less than or equal to 9.5 times a weight of the first carbon material.

In the above structure, the positive electrode active material layer includes an aggregated portion, and a percentage of the aggregated portion in the positive electrode active material layer obtained by image analysis is less than 14%.

Another structure is a secondary battery including a positive electrode active material particle containing lithium and cobalt, a positive electrode active material layer including a first carbon material, a second carbon material, and a resin, and a negative electrode active material layer overlapping with the positive electrode active material layer. A percentage of an aggregated portion in the positive electrode active material layer obtained by image analysis is less than 14%.

In the above structure, a weight of the second carbon material is more than or equal to 1.5 times and less than or equal to 20 times, preferably more than or equal to 2 times and less than or equal to 9.5 times a weight of the first carbon material.

In each of the above structures, the first carbon material is single-layer graphene or multilayer graphene, and the second carbon material is carbon black. Multilayer graphene includes a plurality of sheets of graphene and refers to two to hundred graphene layers.

In each of the above structures, the resin used as the binder is polyvinylidene fluoride.

In each of the above structures, the secondary battery may be a secondary battery including an electrolyte solution or an all-solid-state secondary battery including a solid electrolyte. Note that in the case of the secondary battery including an electrolyte solution, a separator is provided between a positive electrode and a negative electrode. In the case of the all-solid-state secondary battery, a solid electrolyte is provided between a positive electrode and a negative electrode, and a separator is not provided.

Note that an aggregated portion in this specification refers to a region including an aggregate in which one or more kinds of conductive additives are aggregated, and is positioned between a plurality of active materials. FIG. 1A is a cross-sectional image of an electrode having a structure of the present invention in which the first carbon material and the second carbon material are mixed in the above range, and an aggregated portion 10 is shown by a bold line in FIG. 1A for easy understanding. FIG. 1A also shows a void 11. Note that FIG. 1B is a cross-sectional image of the same portion as that in FIG. 1A and shows a state before the bold line is written.

The percentage of the area of the aggregated portion in the electrode plane can be lower than 14%. The area of the aggregated portion is preferably small. Porosity refers to the area proportion of a void (also can be referred to as a pore or a hole) in a cross section of an electrode layer. The porosity in this specification is the average value calculated from 180 images observed with XVision 210B produced by Hitachi High-Tech Corporation, which is an FIB-SEM (Focused Ion Beam-Scanning electron microscope), at an acceleration voltage of 2.0 kV. The void includes a pore or a hole that exists in an active material particle, and refers to a space between active material particles in some cases. The percentage of the area of the void in the electrode plane can be higher than or equal to 3.4% and lower than or equal to 7%. The void is required for an electrolyte solution to penetrate and is preferably kept in the above range. The areas can be measured by slice and view technique using a SEM (scanning electron microscope), which is one of measurement methods using image analysis.

Slice and view technique offers information equivalent to three-dimensional information in such a manner that cross-section processing and SEM observation are performed in this order repeatedly in the FIB-SEM to obtain image data, and the plurality of SEM images with gradually changing depth information are obtained and connected.

FIG. 2A shows an example in which a plurality of cross-section images are arranged by the slice and view technique, and FIG. 2B shows a rectangular solid obtained by connecting them (180 SEM images in total). An arrow in FIG. 2B indicates the observation direction, and a plane perpendicular to the observation direction is a cross section of an electrode. The rectangular solid composed of a group of SEM images has a bottom surface of 36 μm (width)×38.5 μm (depth) and a height of 14.2 μm. FIG. 2C is one SEM image extracted from the rectangular solid. A black region shown in FIG. 3A is extracted as an active material region, a void region shown in FIG. 3B is extracted, and an aggregated portion of a conductive additive is extracted in FIG. 3C to calculate the proportions of their areas. One pixel size in the SEM image is approximately 60 nm, and the aggregated portion and the void region can be distinguished from each other in the range from approximately 60 nm in the case where the difference between the aggregated portion of the conductive additive and the void region is clear. Note that the area ratio is based on the average value of the 180 SEM images. A higher proportion of the active material region is preferable because the capacity becomes higher. In a positive electrode structure of a secondary battery, it is desirable that the proportion of an active material region be high, the area of an aggregated portion be small, and the percentage of the area of a void be higher than or equal to 3.4% and lower than or equal to 7% in the case of employing the slice and view technique.

Within the above range, even when an electrolyte solution is introduced after pressing is performed in the formation process of an electrode, a void into which the electrolyte solution penetrates can be left. An increase in electrode density due to pressing lowers the proportion of a void and thus causes the shortage of an electrolyte solution that penetrates into the void, which inhibits smooth movement of lithium ions and increases the diffusion resistance of the lithium ions in a positive electrode. This leads to a problem of a decrease in rate performance. Increasing the proportion of a void so that an electrolyte solution sufficiently penetrates reduces the electrode density, causing a problem of a decrease in energy performance. In this manner, it has been conventionally difficult to achieve both excellent rate performance and a high energy density. Both excellent rate performance and a high energy density can be achieved when the weight of carbon black to be mixed is more than or equal to 1.5 times and less than or equal to 20 times, preferably more than or equal to 2 times and less than or equal to 9.5 times the weight of graphene and pressing is performed.

In each of the above structures, the porosity of the positive electrode active material layer obtained by the image analysis is higher than or equal to 3.4% and lower than or equal to 7%.

Mixing of the first carbon material (graphene) and the second carbon material (carbon black) in the above range results in a higher electrode density than a positive electrode using only carbon black as a conductive additive. As the electrode density is higher, the capacity per weight unit can be higher.

In each of the above structures, the density of the positive electrode active material layer measured by gravimetry can be higher than 3.5 g/cc.

A powder with the weight W is filled in a pellet dice and gradually pressed uniaxially up to a certain pressure, and powder packing density (hereinafter, PPD) is calculated from the volume V under that pressure (Formula (1) below).

[Formula 1]

PPD=W/V (g/cc) (1)

In the case of a positive electrode using only graphene as a conductive additive, the capacity greatly decreases under the fast charging conditions (high-rate charging conditions). The positive electrode using only graphene as a conductive additive can have a high electrode density but is not suitable for a secondary battery that needs to be charged rapidly.

Although having a lower electrode density than a positive electrode using only graphene as a conductive additive, a positive electrode formed by mixing of the first carbon material (graphene) and the second carbon material (carbon black) in the above range enables fast charging.

The carried amount refers to the amount of active material per electrode area. The carried amount can be calculated because the materials are measured and mixed before formation of a slurry. The carried amount can also be measured by disassembling a secondary battery and dissolving a binder in some cases. The carried amount can be increased by an increase in the proportion of an active material to be compounded (also referred to as mixed) or an increase in layer thickness. Note that a large carried amount increases the resistance of an electrode or the distance to a current collector, which easily degrades the battery performance.

As for the carried amount, in the case of a secondary battery including a positive electrode using only graphene as a conductive additive, the capacity greatly decreases under the fast charging conditions (high-rate charging conditions). Mixing of the first carbon material (graphene) and the second carbon material (carbon black) in the above range enables fast charging even with a large carried amount.

The above is effective in secondary batteries for vehicles.

When a vehicle becomes heavier with increasing number of secondary batteries, more energy is consumed to move the vehicle, which reduces the mileage. With the use of high-density secondary batteries, the mileage of the vehicle including the secondary batteries with the same weight can be maintained with almost no change in the total weight.

Since electric power is needed to charge the secondary battery with higher capacity in the vehicle, charging is desirably finished in a short time. What is called regenerative charging, in which electric power temporarily generated when the vehicle is braked is used for charging, is performed under high-rate charging conditions; thus, a secondary battery for a vehicle is required to have excellent rate performance.

Optimizing the mixing ratio of carbon black to graphene enables both higher electrode density and formation of an appropriate space needed for ion conduction, whereby a secondary battery for a vehicle that has high energy density and favorable output performance can be obtained.

This structure is also effective in a portable information terminal; optimizing the mixing ratio of carbon black to graphene allows a secondary battery to have a smaller size and higher capacity. Optimizing the mixing ratio of carbon black to graphene also enables fast charging of a portable information terminal.

In this specification, a particle has not only a spherical shape but also a variety of cross-sectional shapes. A too large particle diameter of a particle of a positive electrode active material causes problems such as difficulty in lithium diffusion and too much surface roughness of an active material layer in coating to a current collector. By contrast, a too small particle diameter causes problems such as difficulty in carrying an active material layer in coating to a current collector and overreaction with an electrolyte solution. Therefore, an average particle diameter (D50, also referred to as median diameter) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, the D50 is preferably greater than or equal to 1 μm and less than or equal to 40 μm. Alternatively, the D50 is preferably greater than or equal to 1 μm and less than or equal to 30 μm. Alternatively, the D50 is preferably greater than or equal to 2 μm and less than or equal to 100 μm. Alternatively, the D50 is preferably greater than or equal to 2 μm and less than or equal to 30 μm. Alternatively, the D50 is preferably greater than or equal to 5 μm and less than or equal to 100 μm. Alternatively, the D50 is preferably greater than or equal to 5 μm and less than or equal to 40 μm.

The median diameter D50 can be measured with a particle size distribution analyzer or the like using a laser diffraction and scattering method. The specific surface area can be measured with a specific surface area analyzer or the like by a constant-volume gas adsorption method, for example.

In cross-sectional observation, the particle diameter of a primary particle corresponds to the measured value when aggregation does not occur; however, it should be noted that, in the case where primary particles are aggregated to form a secondary particle, a particle size analyzer measures the particle diameter of the aggregated primary particles, that is, the secondary particle.

Note that a carbon material included in a secondary battery can be identified through analysis of its crystal state by Raman spectroscopy or X-ray diffraction. For example, graphene and carbon black can be detected and identified in some cases.

In each of the above structures, the aggregated portion in the positive electrode active material layer is a region where a profile indicating graphene or a profile indicating carbon black is measured by X-ray diffraction.

In each of the above structures, the aggregated portion in the positive electrode active material layer is a region where a profile indicating graphene or a profile indicating carbon black is measured by Raman spectroscopy.

In each of the above structures, the positive electrode active material may further contain nickel. Containing nickel can achieve high capacity.

In each of the above structures, the positive electrode active material may further contain manganese. Containing manganese can improve structural stability.

In each of the above structures, the positive electrode active material may further contain titanium. Containing titanium can improve structural stability or heat resistance.

In each of the above structures, the positive electrode active material may further contain aluminum. Containing aluminum can improve heat resistance.

In each of the above structures, fluorine may be contained in a surface portion of the positive electrode active material. When fluorine is contained in the surface portion of the positive electrode active material, lithium ions are easily inserted or extracted in the surface of the positive electrode, so that excellent rate performance can be obtained. Note that rate performance is also referred to as charging and discharging rate performance and is one of evaluation methods serving as an indicator of fast charging and discharging.

### Effect of the Invention

Using both graphene and carbon black as conductive additives and optimizing the compounding ratio enable a high-density electrode to be obtained. Furthermore, a secondary battery that can inhibit a capacity decrease and keep high capacity can be obtained even when the thickness of an electrode layer and the carried amount increase. This secondary battery is especially effective in a vehicle and can achieve a vehicle that has a high mileage, specifically a driving range per charge of 500 km or longer, without increasing the proportion of the weight of the secondary batteries to the weight of the entire vehicle.

### BRIEF DESCRIPTION OF THE DRAWINGS

FIG. 1A and FIG. 1B are cross-sectional images showing one embodiment of the present invention.

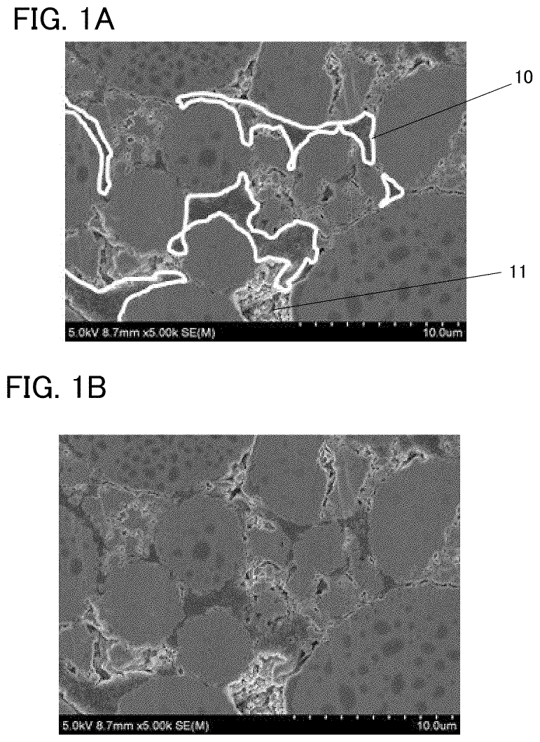

FIG. 2A and FIG. 2B are diagrams showing slice and view technique, and FIG. 2C is a diagram showing a SEM image.

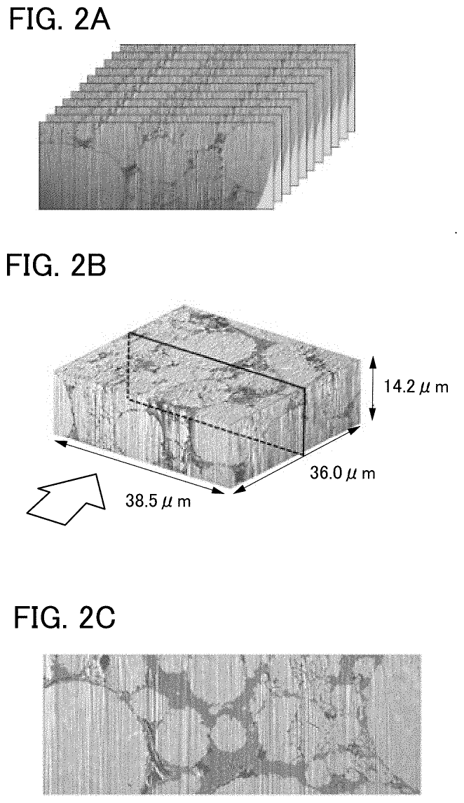

FIG. 3A, FIG. 3B, and FIG. 3C are diagrams obtained by processing a SEM image.

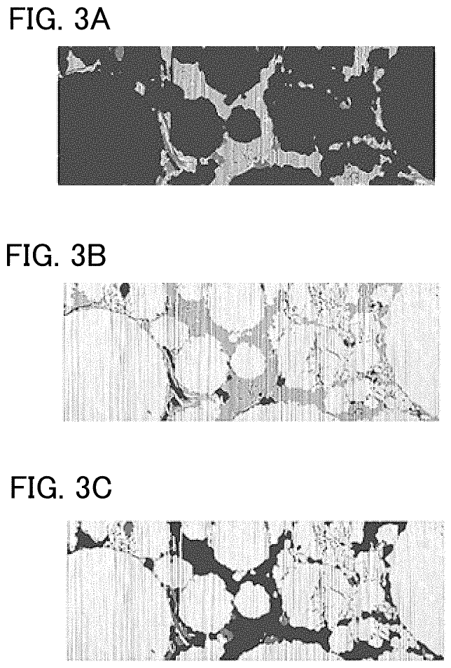

FIG. 4 is a diagram showing an example of a formation method showing one embodiment of the present invention.

FIG. 5 is a graph showing the proportions in an electrode plane.

FIG. 6A is a graph showing a relationship between capacity and the carried amount at a rate of 0.2 C, and FIG. 6B is a graph showing a relationship between capacity and the carried amount at a rate of 1 C.

FIG. 7A is a perspective view of a coin-type secondary battery, FIG. 7B is a cross-sectional perspective view thereof, and FIG. 7C is a schematic cross-sectional view in charging.

FIG. 8A illustrates an example of a cylindrical secondary battery. FIG. 8B illustrates an example of a cylindrical secondary battery. FIG. 8C illustrates an example of a plurality of cylindrical secondary batteries. FIG. 8D illustrates an example of a power storage system including a plurality of cylindrical secondary batteries.

FIG. 9A and FIG. 9B are diagrams illustrating examples of a secondary battery, and FIG. 9C is a diagram illustrating the internal state of a secondary battery.

FIG. 10A, FIG. 10B, and FIG. 10C are diagrams illustrating an example of a secondary battery.

FIG. 11A and FIG. 11B are external views of a secondary battery.

FIG. 12A, FIG. 12B, and FIG. 12C are diagrams illustrating a method for forming a secondary battery.

FIG. 13A illustrates a structure example of a battery pack. FIG. 13B illustrates a structure example of a battery pack. FIG. 13C illustrates a structure example of a battery pack.

FIG. 14A is a perspective view of a battery pack of one embodiment of the present invention, FIG. 14B is a block diagram of a battery pack, and FIG. 14C is a block diagram of a vehicle having a motor.

FIG. 15A to FIG. 15D are diagrams illustrating examples of transport vehicles.

FIG. 16A and FIG. 16B are diagrams illustrating power storage devices of one embodiment of the present invention.

FIG. 17A is a diagram illustrating an electric bicycle, FIG. 17B is a diagram illustrating a secondary battery of an electric bicycle, and FIG. 17C is a diagram illustrating an electric motorcycle.

FIG. 18A to FIG. 18D are diagrams illustrating examples of electronic devices.

FIG. 19A illustrates examples of wearable devices, FIG. 19B is a perspective view of a watch-type device, and FIG. 19C is a diagram illustrating a side surface of a watch-type device.

FIG. 20A and FIG. 20B are cross-sectional SEM images showing one embodiment of the present invention, and FIG. 20C is a cross-sectional SEM image showing a comparative example.

FIG. 21A and FIG. 21B are cross-sectional SEM images showing comparative examples.

### MODE FOR CARRYING OUT THE INVENTION

Embodiments of the present invention are described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

### Embodiment 1

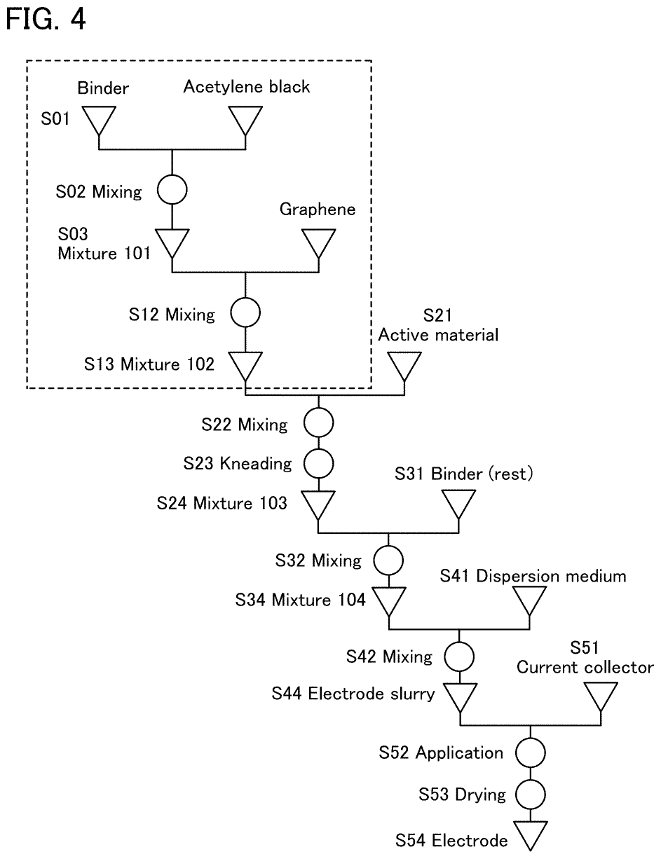

A method for forming a positive electrode of a lithium-ion secondary battery of one embodiment of the present invention will be described with reference to FIG. 4. Described in this embodiment is the case where graphene (also referred to as G) and acetylene black (also referred to as AB) are used as conductive additives.

First, a binder and carbon black (acetylene black in this embodiment) are prepared (Step S01 in FIG. 4). They are mixed (Step S02 in FIG. 4) to form a mixture 101 (Step S03 in FIG. 4). In addition, graphene is prepared and mixed with the mixture 101 (Step S12 in FIG. 4) to form a mixture 102 (Step S13 in FIG. 4).

Although the sequence surrounded by a dotted line in FIG. 4 is described in this embodiment, the sequence is not particularly limited; for example, graphene and the binder may be mixed first, and then acetylene black may be added to be mixed. Moreover, in order to reduce the number of steps, the binder, acetylene black, and graphene may be mixed at the same time.

In the steps surrounded by the dotted line in FIG. 4, the mixed amounts of graphene (a first carbon material) and acetylene black (a second carbon material) are important. Acetylene black is more likely to aggregate than graphene.

Graphene is one kind of graphene compounds. A graphene compound has excellent electrical characteristics of high conductivity and excellent physical properties of high flexibility and high mechanical strength in some cases. A graphene compound has a planar shape. A graphene compound enables low-resistance surface contact. Furthermore, a graphene compound has extremely high conductivity even with a small thickness in some cases and thus allows a conductive path to be formed in an active material layer efficiently even with a small amount. Hence, a graphene compound is preferably used as a conductive additive, in which case the area where the active material and the conductive additive are in contact with each other can be increased. In addition, a graphene compound is preferable because electrical resistance can be reduced in some cases. Here, examples of the graphene compound include graphene, multilayer graphene, multi graphene, graphene oxide, multilayer graphene oxide, multi graphene oxide, reduced graphene oxide, reduced multilayer graphene oxide, reduced multi graphene oxide, and graphene quantum dots.

Mixing is performed such that the weight of acetylene black is more than or equal to 1.5 times and less than or equal to 20 times, preferably more than or equal to 2 times and less than or equal to 9.5 times that of graphene, thereby preventing aggregation and reducing the proportion of an aggregated portion to be formed later in an electrode. When graphene and acetylene black are mixed in the above range, acetylene black is excellent in dispersion stability and an aggregated portion is unlikely to be generated at the time of preparing a slurry. In this embodiment, the weight ratio of graphene to acetylene black is 2:8 (i.e., 1:4).

As the binder, polyvinylidene fluoride (PVDF), polyimide, polytetrafluoroethylene, polyvinyl chloride, ethylene-propylene-diene polymer, styrene-butadiene rubber, acrylonitrile-butadiene rubber, fluorine rubber, polyvinyl acetate, polymethyl methacrylate, polyethylene, nitrocellulose, or the like can be used.

Next, an active material is prepared (Step S21 in FIG. 4) and mixed with the mixture 102 (Step S22 in FIG. 4), and then kneading is performed (Step S23 in FIG. 4). Kneading here refers to stirring or mixing with a mixer and is the same as mixing in a broad sense. Thus, mixing in the other steps may be performed using a mixer. After the kneading, a mixture 103 is obtained (Step S24 in FIG. 4).

It is preferable that a positive electrode active material be used as the active material and a metal serving as a carrier ion (hereinafter, an element A) be contained. As the element A, an alkali metal such as lithium, sodium, or potassium or a Group 2 element such as calcium, beryllium, or magnesium can be used, for example.

In the positive electrode active material, carrier ions are extracted from the positive electrode active material due to charging. A larger amount of the extracted element A means a larger amount of ions contributing to the capacity of a secondary battery, increasing the capacity. Meanwhile, a large amount of the extracted element A easily causes collapse of the crystal structure of a compound contained in the positive electrode active material. Collapse of the crystal structure of the positive electrode active material may lead to a decrease in the discharge capacity due to charge and discharge cycles. The positive electrode active material of one embodiment of the present invention contains an element X, whereby collapse of a crystal structure that would occur when carrier ions are extracted in charging of a secondary battery may be suppressed. Part of the element X substitutes at an element A position, for example. An element such as magnesium, calcium, zirconium, lanthanum, or barium can be used as the element X As another example, an element such as copper, potassium, sodium, or zinc can be used as the element X Two or more of the elements described above as the element X may be used in combination.

Furthermore, the positive electrode active material preferably contains halogen in addition to the element X The positive electrode active material preferably contains halogen such as fluorine or chlorine. When the positive electrode active material contains the halogen, substitution of the element X at the position of the element A is promoted in some cases.

In the case where the positive electrode active material contains the element X or contains halogen in addition to the element X, electrical conductivity on the surface of the positive electrode active material is sometimes suppressed.

The positive electrode active material contains a metal whose valence number changes due to charging and discharging of a secondary battery (hereinafter, an element M). The element M is a transition metal, for example. The positive electrode active material contains one or more of cobalt, nickel, and manganese, particularly cobalt, as the element M, for example. The positive electrode active material may contain, at an element M position, an element that has no valence number change and can have the same valence number as the element M, such as aluminum, specifically, a trivalent representative element, for example. The above-described element X may be substituted at the element M position, for example. In the case where the positive electrode active material is an oxide, the element X may substitute at an oxygen position.

As the positive electrode active material, a lithium composite oxide having a layered rock-salt crystal structure is preferably used, for example. Specifically, as the lithium composite oxide having a layered rock-salt crystal structure, lithium cobalt oxide, lithium nickel oxide, a lithium composite oxide containing nickel, manganese, and cobalt, or a lithium composite oxide containing nickel, cobalt, and aluminum can be used, for example. Moreover, such a positive electrode active material is preferably represented by a space group R-3m.

In the positive electrode active material having a layered rock-salt crystal structure, increasing the charge depth may cause collapse of a crystal structure. Here, collapse of a crystal structure refers to displacement of a layer, for example. In the case where collapse of a crystal structure is irreversible, the capacity of a secondary battery might be decreased by repeated charging and discharging.

The positive electrode active material includes the element X, whereby the displacement of a layer can be suppressed even when the charge depth is increased, for example. By suppressing the displacement, a change in volume due to charging and discharging can be small. Accordingly, the positive electrode active material can achieve excellent cycle performance. In addition, the positive electrode active material can have a stable crystal structure in a high-voltage charged state. A crystal structure with a charge depth of 0 (in a discharged state) is R-3m (O3), and in the case of a charge depth in a sufficiently charged state, a crystal whose structure is different from the H1-3 type crystal structure is included. This structure belongs to the space group R-3m and is a structure in which an ion of cobalt, magnesium, or the like occupies a site coordinated to six oxygen atoms. Furthermore, the symmetry of CoO₂ layers of this structure is the same as that in the O3 type structure. Accordingly, this structure is referred to as an O3′ type crystal structure or a pseudo-spinel crystal structure in this specification and the like. In both the O3 type crystal structure and the O3′ type crystal structure, a slight amount of magnesium preferably exists between the CoO₂ layers, i.e., in lithium sites. In addition, a slight amount of fluorine preferably exists at random in oxygen sites.

Note that in the O3′ type crystal structure, a light element such as lithium sometimes occupies a site coordinated to four oxygen atoms.

The O3′ type crystal structure is preferably represented by a unit cell including one cobalt atom and one oxygen atom. This means that the symmetry of cobalt and oxygen differs between the O3′ structure and the H1-3 type structure, and the amount of change from the O3 structure is smaller in the O3′ structure than in the H1-3 type structure. A preferred unit cell for representing a crystal structure in a positive electrode active material is selected such that the value of GOF (goodness of fit) is smaller in Rietveld analysis of XRD, for example.

In the unit cell of the O3′ type crystal structure, the coordinates of cobalt and oxygen can be represented by Co (0, 0, 0.5) and O (0, 0, x) within the range of 0.20≤x≤0.25.

The positive electrode active material may be represented by the chemical formula AM_{y}O_{z} (y>0, z>0). For example, lithium cobalt oxide may be represented by LiCoO₂. As another example, lithium nickel oxide may be represented by LiNiO₂. A material with a layered rock-salt crystal structure, such as lithium cobalt oxide (LiCoO₂), is known to have a high discharge capacity and excel as a positive electrode active material of a secondary battery. An example of the material with a layered rock-salt crystal structure is a composite oxide represented by LiMO₂.

In lithium cobalt oxide with a charge depth of 0 (discharged state), there is a region having a crystal structure belonging to the space group R-3m, lithium occupies octahedral sites, and a unit cell includes three CoO₂ layers. Thus, this crystal structure is referred to as an O3 type crystal structure in some cases. Note that the CoO₂ layer has a structure in which an octahedral structure with cobalt coordinated to six oxygen atoms continues on a plane in an edge-shared state.

Lithium cobalt oxide with a charge depth of 1 has the crystal structure belonging to the space group P-3m1 and includes one CoO₂ layer in a unit cell. Hence, this crystal structure is referred to as an O1 type crystal structure in some cases.

Lithium cobalt oxide with a charge depth of approximately 0.8 has the crystal structure belonging to the space group R-3m. This structure can also be regarded as a structure in which CoO₂ structures such as a structure belonging to P-3m1 (O1) and LiCoO₂ structures such as a structure belonging to R-3m (O3) are alternately stacked. Thus, this crystal structure is referred to as an H1-3 type crystal structure in some cases. Note that the number of cobalt atoms per unit cell in the actual H1-3 type crystal structure is twice that in other structures.

The O3′ type crystal structure exhibits diffraction peaks at 2θ of 19.30±0.20° (greater than or equal to 19.10° and less than or equal to 19.50°) and 2θ of 45.55±0.10° (greater than or equal to 45.45° and less than or equal to 45.65°). More specifically, the O3′ type crystal structure exhibits sharp diffraction peaks at 2θ of 19.30±0.10° (greater than or equal to 19.20° and less than or equal to 19.40°) and 2θ of 45.55±0.05° (greater than or equal to 45.50° and less than or equal to 45.60°).

By contrast, the H1-3 type crystal structure and CoO₂ (P-3m1, O1) do not exhibit peaks at these positions. Thus, the peaks at 2θ of 19.30±0.20° and 2θ of 45.55±0.10° in a high-voltage charged state can be the features of the positive electrode active material having the O3′ type crystal structure.

Although the positive electrode active material of one embodiment of the present invention has the O3′ type crystal structure at the time of high-voltage charging, not all the particles necessarily have the O3′ type crystal structure. Some of the particles may have another crystal structure or be amorphous. Note that when the XRD patterns are subjected to the Rietveld analysis, the O3′ type crystal structure preferably accounts for greater than or equal to 50 wt %, further preferably greater than or equal to 60 wt %, still further preferably greater than or equal to 66 wt %. The positive electrode active material in which the O3′ type crystal structure accounts for greater than or equal to 50 wt %, preferably greater than or equal to 60 wt %, further preferably greater than or equal to 66 wt % can have sufficiently good cycle performance.

Furthermore, even after 100 or more cycles of charging and discharging after the measurement starts, the O3′ type crystal structure preferably accounts for greater than or equal to 35 wt %, further preferably greater than or equal to 40 wt %, still further preferably greater than or equal to 43 wt %, in the Rietveld analysis.

When the magnesium concentration is higher than a desired value, the effect of stabilizing a crystal structure becomes small in some cases. This is probably because magnesium enters the cobalt sites in addition to the lithium sites. The number of magnesium atoms in the positive electrode active material of one embodiment of the present invention is preferably greater than or equal to 0.001 times and less than or equal to 0.1 times, further preferably greater than 0.01 times and less than 0.04 times, still further preferably approximately 0.02 times the number of atoms of the transition metal M. Alternatively, the number of magnesium atoms in the positive electrode active material of one embodiment of the present invention is preferably greater than or equal to 0.001 times and less than 0.04 or greater than or equal to 0.01 times and less than or equal to 0.1 times the number of atoms of the transition metal M. The magnesium concentration described here may be a value obtained by element analysis on the whole particles of the positive electrode active material using ICP-MS or the like, or may be a value based on the ratio of the raw materials mixed in the process of forming the positive electrode active material, for example.

The number of nickel atoms in the positive electrode active material is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, the number of nickel atoms in the positive electrode active material is preferably greater than 0% and less than or equal to 4%, greater than 0% and less than or equal to 2%, greater than or equal to 0.05% and less than or equal to 7.5%, greater than or equal to 0.05% and less than or equal to 2%, greater than or equal to 0.1% and less than or equal to 7.5%, or greater than or equal to 0.1% and less than or equal to 4% of the number of cobalt atoms. The nickel concentration described here may be a value obtained by element analysis on the whole particles of the positive electrode active material using GD-MS, ICP-MS, or the like, or may be a value based on the ratio of the raw materials mixed in the process of forming the positive electrode active material, for example.

The positive electrode active material is not limited to the materials described above.

As the positive electrode active material, a composite oxide with a spinel crystal structure can be used, for example. Alternatively, a polyanionic material can be used as the positive electrode active material, for example. Examples of the polyanionic material include a material with an olivine crystal structure and a material with a NASICON structure. Alternatively, a material containing sulfur can be used as the positive electrode active material, for example.

As the material with a spinel crystal structure, for example, a composite oxide represented by LiM₂O₄ can be used. It is preferable to contain Mn as the element M. For example, LiMn₂O₄ can be used. It is preferable to contain Ni in addition to Mn as the element M because the discharge voltage and the energy density of the secondary battery are increased in some cases. It is preferable to add a small amount of lithium nickel oxide (LiNiO₂ or LiNi₁₋ₓMₓO₂ (M=Co, Al, or the like)) to a lithium-containing material with a spinel crystal structure which contains manganese, such as LiMn₂O₄, because the performance of the secondary battery can be improved.

As a polyanionic material, for example, a composite oxide containing oxygen, the metal A, the metal M, and an element Z can be used. The metal A is one or more of Li, Na, and Mg; the metal M is one or more of Fe, Mn, Co, Ni, Ti, V, and Nb; and the element Z is one or more of S, P, Mo, W, As, and Si.

As the material with an olivine crystal structure, for example, a composite material (general formula LiMPO₄ (M is one or more of Fe(II), Mn(II), Co(II), and Ni(II)) can be used. Typical examples of the general formula LiMPO₄ include lithium compounds such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≤1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≤1, 0<c<1, 0<d<1, and 0<e<1), and LiFe_{f}Ni_{g}CoₕMnᵢPO₄ (f+g+h+i≤1, 0<f<1, 0<g<1, 0<h<1, and 0<i<1).

Alternatively, a composite material such as a general formula Li₍₂₋ⱼ₎MSiO₄ (M is one or more of Fe(II), Mn(II), Co(II), and Ni(II); 0≤j≤2) can be used. Typical examples of the general formula Li₍₂₋ⱼ₎MSiO₄ include lithium compounds such as Li₍₂₋ⱼ₎FeSiO₄, Li₍₂₋ⱼ₎NiSiO₄, Li₍₂₋ⱼ₎CoSiO₄, Li₍₂₋ⱼ₎MnSiO₄, Li₍₂₋ⱼ₎FeₖNiₗSiO₄, Li₍₂₋ⱼ₎FeₖCoₗSiO₄, Li₍₂₋ⱼ₎FeₖMnₗSiO₄, Li₍₂₋ⱼ₎NiₖCoₗSiO₄, Li₍₂₋ⱼ₎NiₖMnₗSiO₄ (k+l≤1, 0<k<1, and 0<l<1), Li₍₂₋ⱼ₎FeₘNiₙCo_{q}SiO₄, Li₍₂₋ⱼ₎FeₘNiₙMn_{q}SiO₄, Li₍₂₋ⱼ₎NiₘCoₙMn_{q}SiO₄ (m+n+q≤1, 0<m<1, 0<n<1, and 0<q<1), and Li₍₂₋ⱼ₎FeᵣNiₛCoₜMnᵤSiO₄ (r+s+t+u≤1, 0<r<1, 0<s<1, 0<t<1, and 0<u<1).

Still alternatively, a NASICON compound represented by a general formula AₓM₂(XO₄)₃ (A=Li, Na, or Mg, M=Fe, Mn, Ti, V, or Nb, X=S, P, Mo, W, As, or Si) can be used. Examples of the NASICON compound include Fe₂(MnO₄)₃, Fe₂(SO₄)₃, and Li₃Fe₂(PO₄)₃. Further alternatively, a compound represented by a general formula Li₂MPO₄F, Li₂MP₂O₇, or Li₅MO₄ (M=Fe or Mn) can be used as the positive electrode active material.

Further alternatively, a perovskite fluoride such as NaFeF₃ and FeF₃, a metal chalcogenide (a sulfide, a selenide, or a telluride) such as TiS₂ and MoS₂, an oxide with an inverse spinel crystal structure such as LiMVO₄, a vanadium oxide (V₂O₅, V₆O₁₃, LiV₃O₈, or the like), a manganese oxide, an organic sulfur compound, or the like may be used as the positive electrode active material.

Alternatively, a borate-based material represented by a general formula LiMBO₃ (M is Fe(II), Mn(II), or Co(II)) may be used as the positive electrode active material.

As a material containing sodium, for example, an oxide containing sodium such as NaFeO₂, Na_{2/3}[Fe_{1/2}Mn_{1/2}]O₂, Na_{2/3}[Ni_{1/3}Mn_{2/3}]O₂, Na₂Fe₂(SO₄)₃, Na₃V₂(PO₄)₃, Na₂FePO₄F, NaVPO₄F, NaMPO₄ (M is Fe(II), Mn(II), Co(II), or Ni(II)), Na₂FePO₄F, or Na₄Co₃(PO₄)₂P₂O₇ may be used as the positive electrode active material.

As the positive electrode active material, a lithium-containing metal sulfide may be used. Examples of the lithium-containing metal sulfide include Li₂TiS₃ and Li₃NbS₄.

A mixture of two or more of the above-described materials may be used as the positive electrode active material of one embodiment of the present invention.

In this embodiment, a lithium composite oxide containing Ni, Co, and Mn in a ratio of 8:1:1 (also referred to as NCM) is used as the positive electrode active material. The NCM is widely used in terms of cost advantages and higher capacity, and graphene to be added later plays an important role in maximizing the performance of the NCM.

Next, the binder (rest) is prepared (Step S31 in FIG. 4), and the mixture 103 and the binder are mixed (Step S32 in FIG. 4) to form a mixture 104 (Step S34 in FIG. 4). In this embodiment, the same binder is mixed in two steps, Step S01 and Step S31. The total mixed amount of the binder in Step S01 and Step S31 is set depending on the amounts of acetylene black, graphene, and active material; the binder is added such that the weight ratio of the binder to the electrode slurry is higher than or equal to 1 wt % and lower than or equal to 5 wt %. The binder is mixed while graphene is dispersed to make surface contact with a plurality of active material particles, so that the active material and graphene can be bound to each other with the dispersion state kept. Mixing of the binder can improve the strength of the electrode.

Next, a dispersion medium is prepared (Step S41 in FIG. 4) and is added to the mixture 104 and mixed until a predetermined viscosity is obtained (Step S42 in FIG. 4).

A polar solvent is preferably used as the dispersion medium. As the polar solvent, N-methyl-2-pyrrolidone (abbreviation: NMP), N,N-dimethylformamide (abbreviation: DMF), dimethylsulfoxide (abbreviation: DMSO), or the like can be used. In this embodiment, the viscosity is adjusted by mixing NMP as the dispersion medium, so that the slurry is formed.

Through the above steps, the electrode slurry can be formed (Step S44 in FIG. 4).

Next, a current collector is prepared (Step S51 in FIG. 4), and the electrode slurry formed in Step S44 is provided on one surface or both surfaces of the current collector by an application method such as a roll coating method using an applicator roll or the like, a screen printing method, a doctor blade method, a spin coating method, or a bar coating method, for example (Step S52 in FIG. 4).

In the case where a positive electrode is formed, a positive electrode current collector is used as the current collector. The positive electrode current collector can be formed using a material that has high conductivity, such as a metal like stainless steel, gold, platinum, aluminum, or titanium, or an alloy thereof. It is preferable that a material used for the positive electrode current collector not dissolve at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape (sheet-like shape), a net-like shape, a punching-metal shape, an expanded-metal shape, or the like as appropriate. The current collector preferably has a thickness of greater than or equal to 5 μm and less than or equal to 30 μm.

The electrode slurry applied to the current collector is dried by a method such as ventilation drying or reduced pressure (vacuum) drying (Step S53 in FIG. 4). This drying is performed with the use of hot air at higher than or equal to 50° C. and lower than or equal to 170° C. for longer than or equal to 1 minute and shorter than or equal to 10 hours, preferably longer than or equal to 1 minute and shorter than or equal to 1 hour, for example. Through this step, the dispersion medium contained in the electrode slurry is evaporated. There is no particular limitation on the atmosphere of the drying.

Through the above steps, the electrode including graphene and acetylene black as the conductive additives and functioning as the positive electrode can be formed (Step S54 in FIG. 4).

With a large amount of the active material, the capacity of the positive electrode to be formed increases, but the contents of graphene and acetylene black serving as the conductive additives relatively decrease. An excessively small amount of the conductive additive results in reduction of the conductivity and battery performance. Thus, the preferred mixed amounts of the active material and the conductive additive are such that the conductivity can be ensured and the amount of the active material is the maximum. Specifically, the weight ratio (wt %) of graphene is preferably higher than or equal to 0.1 wt % and lower than or equal to 10 wt %, further preferably higher than or equal to 0.2 wt % and lower than or equal to 6 wt % in the compounding ratio at the time of forming the electrode slurry described later, i.e., the weight ratio of the active material to the conductive additive and the binder in their total weight. Within the above range, mixing is performed such that the weight of acetylene black is more than or equal to 1.5 times and less than or equal to 20 times, preferably more than or equal to 2 times and less than or equal to 9.5 times that of graphene. In this embodiment, the active material, graphene, acetylene black, and the binder are compounded at a ratio of 95:0.6:2.4:2.

A lithium-ion secondary battery functions with the movement of electrons and the movement of Li ions. The conductive additive (both graphene and acetylene black in this embodiment) promotes the movement of electrons. In order to promote the movement of Li ions, fluorine or the like may be contained in a region that is approximately 10 nm in depth from a surface toward an inner portion, i.e., a surface portion, of the positive electrode active material.

In the case where fluorine is contained in the surface portion, fluorine preferably has a bond with cobalt. As a result, part of Co³⁺ close to fluorine preferably becomes Co²⁺.

The valence of cobalt can be analyzed by electron spin resonance (ESR), for example. In a layered rock-salt crystal structure, Co³⁺ exhibits diamagnetism and Co³⁺ exhibits paramagnetism. The magnetic susceptibility x of a diamagnetic material does not change with a temperature change. By contrast, the magnetic susceptibility χ of a paramagnetic material increases with decreasing temperature, and the number of spins observed by ESR increases.

Hence, when the difference in the number of spins of cobalt observed by ESR between normal temperature (approximately 300 K) and low temperature (approximately 113 K) is found to be more than or equal to 1.0×10¹² spins/g through comparison, at least part of cobalt is probably paramagnetic cobalt. It is thus presumed that Co²⁺ is contained in the surface portion or the like and a bond between fluorine and cobalt exists. When Co²⁺ is contained in the surface portion or the like, lithium ions are easily inserted and extracted in some cases. This is preferable because a positive electrode active material sometimes has improved rate performance.

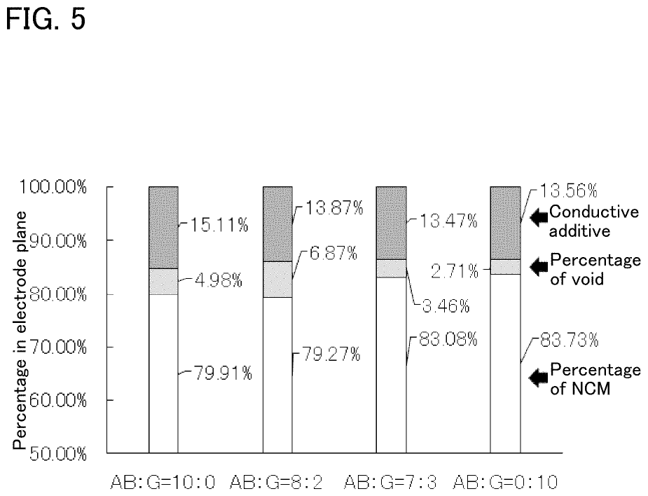

The area of a void region in the electrode obtained in this embodiment is extracted using slice and view technique, and the percentage of the area (also referred to as percentage of void or porosity) is calculated to be 6.87%. FIG. 5 shows the results. Furthermore, the area of the active material (percentage of NCM) is 79.27%, and the percentage of the aggregated portion including the conductive additive is 13.87%.

An example is shown in which the weight ratio of acetylene black to graphene used as the conductive additives is 7:3. The percentage of the void is 3.46%, the percentage of NCM is 83.08%, and the percentage of the aggregated portion including the conductive additives is 13.47%.

According to the results in FIG. 5, mixing performed such that the weight of acetylene black is more than or equal to 1.5 times and less than or equal to 20 times, preferably more than or equal to 2 times and less than or equal to 9.5 times that of graphene can prevent the aggregation of acetylene black and the aggregation of graphene and can reduce the proportion of the aggregated portions. The percentage of the area of the aggregated portion in the electrode plane can be lower than 14%. The area of the aggregated portion is preferably small. The percentage of the area of the void in the electrode plane can be higher than or equal to 3.4% and lower than or equal to 7%.

FIG. 5 also shows an example in which only acetylene black is used as the conductive additive and an example in which only graphene is used as the conductive additive for comparison. Note that in the two comparative examples, the active material, the conductive additive (graphene or acetylene black), and the binder are compounded at a ratio of 95:3:2.

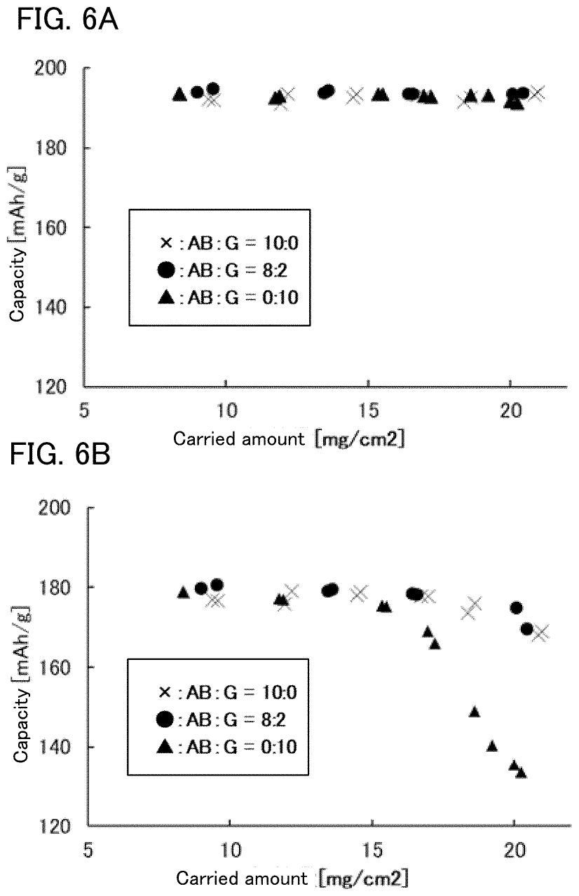

FIG. 6 shows graphs in each of which the horizontal axis represents the carried amount of the electrodes in this embodiment and the vertical axis represents the capacity thereof.

FIG. 6A shows the carried amount dependence in the case where the discharge performance is measured at a rate of 0.2 C, revealing the same results. FIG. 6B shows the carried amount dependence in the case where the discharge performance is measured at a rate of 1 C, revealing that the capacity significantly decreases when only graphene is used.

Here, a charging rate and a discharging rate will be described. The charging rate refers to the relative ratio of constant current charging current to battery capacity, i.e., current value in charging [A]÷ battery capacity [Ah], and is also referred to as C rate. It is expressed in a unit C. For example, in the case where a battery having a capacity of 10 Ah is charged at a constant current of 2 A, charging is regarded as being performed at a rate of 0.2 C. A charging rate of 1 C refers to the amount of current with which a battery is charged completely for one hour. The higher the charging rate is, the higher the speed of charging is. Furthermore, a discharging rate refers to the relative ratio of constant current discharging current to battery capacity, i.e., current value in discharging [A]÷ battery capacity [Ah], and is also referred to as C rate. It is expressed in a unit C. For example, in the case where a battery having a capacity of 10 Ah is discharged at a constant current of 2 A, discharging is regarded as being performed at a rate of 0.2 C. A discharging rate of 1 C refers to the amount of current with which a battery is discharged completely for one hour. The higher the discharging rate is, the higher the speed of discharging is.

The averages of the electrode densities are measured; the average is approximately 3.74 g/cc in the comparative example in which only graphene is used as the conductive additive, and is approximately 3.56 g/cc in the comparative example in which only acetylene black is used as the conductive additive. The average is approximately 3.62 g/cc in the case where graphene and acetylene black are used as the conductive additives.

The electrode density is high but the carried amount dependence at a rate of 1 C is poor in the comparative example in which only graphene is used as the conductive additive, which is not suitable in the case where the electrode is made thick, for example. The comparative example in which only graphene is used as the conductive additive can be regarded as exhibiting poor output performance.

It is difficult to increase the electrode density in the comparative example in which only acetylene black is used as the conductive additive.

According to the results in FIG. 5 and FIG. 6, when both graphene and acetylene black are used as the conductive additives, the electrode density can be higher and the output performance can be maintained as compared with the comparative examples. Using both graphene and acetylene black as the conductive additives produces synergistic effects such as improving the dispersibility of the conductive additives, inhibiting generation of the aggregates of the conductive additives, and inhibiting a reduction of the area of the void into which the electrolyte solution penetrates.

This embodiment is especially effective in a positive electrode of a secondary battery used in a vehicle. A secondary battery used in a vehicle includes an electrode including a positive electrode active material layer having a thickness of larger than 50 μm, i.e., an electrode having a large carried amount, and the use of both graphene and acetylene black as conductive additives offers advantages in that the charge and discharge performance does not degrade even with a high density and a large carried amount.

### Embodiment 2

In this embodiment, a lithium-ion secondary battery including a positive electrode formed by the formation method of one embodiment of the present invention will be described. A lithium-ion secondary battery includes at least a positive electrode, a negative electrode, a separator, and an electrolyte solution.

### [Positive Electrode]

The positive electrode includes a positive electrode active material layer and a positive electrode current collector, and is preferably formed by the formation method described in Embodiment 1.

### [Negative Electrode]

The negative electrode includes a negative electrode active material layer and a negative electrode current collector. The negative electrode active material layer may contain a conductive additive and a binder.

### <Negative Electrode Active Material>

As a negative electrode active material, for example, an alloy-based material or a carbon material can be used.

For the negative electrode active material, an element that enables charge-discharge reactions by alloying and dealloying reactions with lithium can be used. For example, a material containing at least one of silicon, tin, gallium, aluminum, germanium, lead, antimony, bismuth, silver, zinc, cadmium, indium, and the like can be used. Such elements have higher capacity than carbon, and especially, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge-discharge reactions by alloying and dealloying reactions with lithium and a compound containing the element, for example, may be referred to as an alloy-based material.

In this specification and the like, SiO refers, for example, to silicon monoxide. Note that SiO can alternatively be expressed as SiOₓ. Here, it is preferable that x be 1 or have an approximate value of 1. For example, x is preferably greater than or equal to 0.2 and less than or equal to 1.5, further preferably greater than or equal to 0.3 and less than or equal to 1.2.

As the carbon material, graphite, graphitizing carbon (soft carbon), non-graphitizing carbon (hard carbon), carbon nanotube, graphene, carbon black, and the like can be used.

Examples of graphite include artificial graphite and natural graphite. Examples of artificial graphite include meso-carbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it is relatively easy to have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are intercalated into graphite (when a lithium-graphite intercalation compound is formed). For this reason, a lithium-ion secondary battery can have a high operating voltage. In addition, graphite is preferred because of its advantages such as a relatively high capacity per unit volume, relatively small volume expansion, low cost, and higher level of safety than that of a lithium metal.

Alternatively, for the negative electrode active material, an oxide such as titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), or molybdenum oxide (MoO₂) can be used.

Still alternatively, for the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of high charge and discharge capacity (900 mAh/g and 1890 mAh/cm³).

A composite nitride of lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the nitride containing lithium and a transition metal can be used for the negative electrode active material by extracting the lithium ions contained in the positive electrode active material in advance.

Alternatively, a material that causes a conversion reaction can be used for the negative electrode active material. For example, a transition metal oxide that does not form an alloy with lithium, such as cobalt oxide (CoO), nickel oxide (NiO), and iron oxide (FeO), may be used. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive additive and the binder that can be included in the negative electrode active material layer, materials similar to those of the conductive additive and the binder that can be included in the positive electrode active material layer can be used.

### <Negative Electrode Current Collector>

For the negative electrode current collector, a material similar to that of the positive electrode current collector can be used. Note that a material that is not alloyed with carrier ions of lithium or the like is preferably used for the negative electrode current collector.

### [Separator]

The separator is positioned between the positive electrode and the negative electrode. As the separator, for example, a fiber containing cellulose such as paper; nonwoven fabric; a glass fiber; ceramics; a synthetic fiber using nylon (polyamide), vinylon (polyvinyl alcohol-based fiber), polyester, acrylic, polyolefin, or polyurethane; or the like can be used. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at a high voltage can be suppressed and thus the reliability of the secondary battery can be improved. In addition, when the separator is coated with the fluorine-based material, the separator is easily brought into close contact with an electrode, resulting in high output performance. When the separator is coated with the polyamide-based material, in particular, aramid, heat resistance is improved; thus, the safety of the secondary battery is improved.

For example, both surfaces of a polypropylene film may be coated with a mixed material of aluminum oxide and aramid. Alternatively, a surface of the polypropylene film that is in contact with the positive electrode may be coated with the mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

Alternatively, the use of one or more ionic liquids (room temperature molten salts) that are less likely to burn and volatize as the solvent of the electrolyte solution can prevent a power storage device from exploding or catching fire even when the power storage device internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As an electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used, or two or more of these lithium salts can be used in an appropriate combination in an appropriate ratio.

The electrolyte solution used for a power storage device is preferably highly purified and contains a small number of dust particles or elements other than the constituent elements of the electrolyte solution (hereinafter, also simply referred to as “impurities”). Specifically, the weight ratio of impurities to the electrolyte solution is preferably less than or equal to 1%, further preferably less than or equal to 0.1%, still further preferably less than or equal to 0.01%.

An additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of the additive agent in the whole solvent is, for example, higher than or equal to 0.1 wt % and lower than or equal to 5 wt %.

Alternatively, a polymer gel electrolyte obtained in such a manner that a polymer is swelled with an electrolyte solution may be used.

When a polymer gel electrolyte is used, safety against liquid leakage and the like is improved. Furthermore, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. Examples include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based inorganic material or an oxide-based inorganic material, or a solid electrolyte including a high-molecular material such as a PEO (polyethylene oxide)-based high-molecular material may alternatively be used. When the solid electrolyte is used, a separator or a spacer is not necessary. Furthermore, the battery can be entirely solidified; therefore, there is no possibility of liquid leakage and thus the safety is dramatically increased.

Thus, application of the positive electrode slurry or the electrode formed by the formation method of one embodiment of the present invention to an all-solid-state battery is possible. Application of the positive electrode slurry or the electrode to an all-solid-state battery enables the all-solid-state battery to have a high level of safety and excellent characteristics.

### Embodiment 3

This embodiment will describe examples of shapes of several types of secondary batteries including a positive electrode or a negative electrode formed by the formation method described in the above embodiment.

### [Coin-Type Secondary Battery]

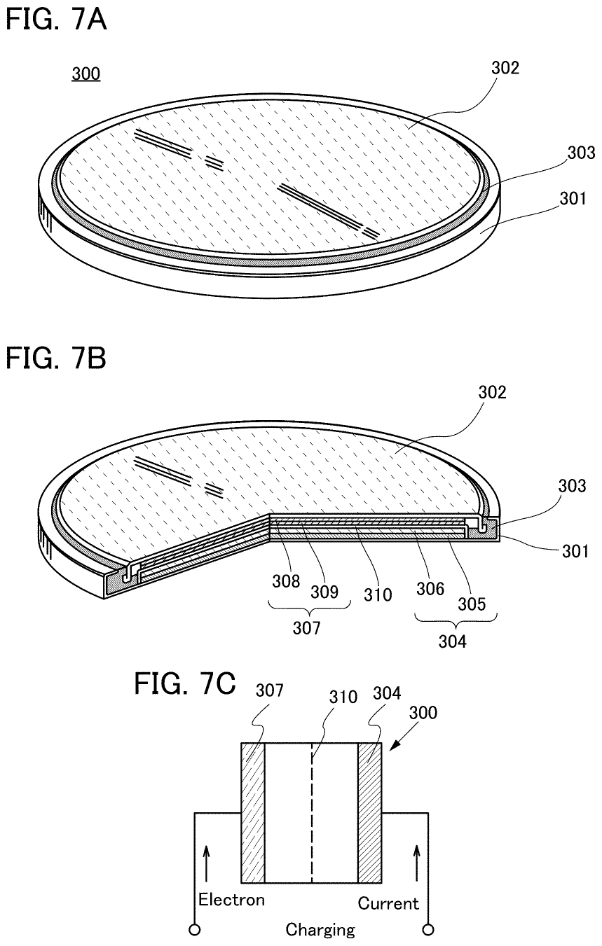

An example of a coin-type secondary battery is described. FIG. 7A is an external view of a coin-type (single-layer flat type) secondary battery, and FIG. 7B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. Alternatively, the positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and a separator 310 are soaked in the electrolyte. Then, as illustrated in FIG. 7B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 located therebetween. In such a manner, the coin-type secondary battery 300 is manufactured.

When the positive electrode 304 is formed by the formation method described in the above embodiment, the coin-type secondary battery 300 can have high capacity.

Here, a current flow in charging a secondary battery is described with reference to FIG. 7C. When a secondary battery using lithium is regarded as a closed circuit, the direction of transfer of lithium ions is the same as the direction of a current flow. Note that in the secondary battery using lithium, the anode and the cathode interchange in charging and discharging, and the oxidation reaction and the reduction reaction interchange; hence, an electrode with a high reaction potential is called a positive electrode and an electrode with a low reaction potential is called a negative electrode. For this reason, in this specification, the positive electrode is referred to as a “positive electrode” or a “plus electrode” and the negative electrode is referred to as a “negative electrode” or a “minus electrode” in all the cases where charging is performed, discharging is performed, a reverse pulse current is supplied, and a charging current is supplied. The use of the terms “anode” and “cathode” related to an oxidation reaction and a reduction reaction might cause confusion because the anode and the cathode interchange in charging and discharging. Thus, the terms “anode” and “cathode” are not used in this specification. If the term “anode” or “cathode” is used, it should be mentioned that the anode or the cathode is which of the one at the time of charging or the one at the time of discharging and corresponds to which of a positive (plus) electrode or a negative (minus) electrode.

Two terminals illustrated in FIG. 7C are connected to a charger, and the secondary battery 300 is charged. As the charging of the secondary battery 300 proceeds, a potential difference between electrodes increases.

### [Cylindrical Secondary Battery]

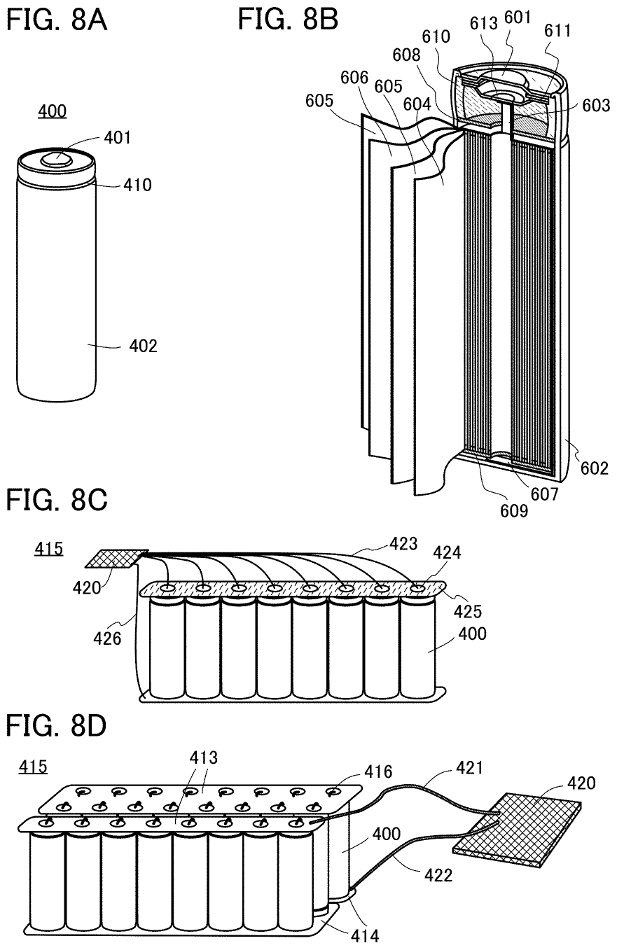

An example of a cylindrical secondary battery is described with reference to FIG. 8A. A cylindrical secondary battery 400 includes, as illustrated in FIG. 8A, a positive electrode cap (battery lid) 401 on a top surface and a battery can (outer can) 402 on a side surface and a bottom surface. The positive electrode cap 401 and the battery can (outer can) 402 are insulated from each other by a gasket (insulating packing) 410.

FIG. 8B is a schematic cross-sectional view of a cylindrical secondary battery. The cylindrical secondary battery illustrated in FIG. 8B includes a positive electrode cap (battery lid) 601 on a top surface and a battery can (outer can) 602 on a side surface and a bottom surface. The positive electrode cap and the battery can (outer can) 602 are insulated from each other by a gasket (insulating packing) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a center pin. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. Alternatively, the battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not illustrated) is injected inside the battery can 602 provided with the battery element. As the nonaqueous electrolyte solution, a nonaqueous electrolyte solution that is similar to that of the coin-type secondary battery can be used.

Since a positive electrode and a negative electrode that are used for a cylindrical storage battery are wound, active materials are preferably formed on both surfaces of a current collector. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold value. The PTC element 611, which serves as a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element.

FIG. 8C illustrates an example of a power storage system 415. The power storage system 415 includes a plurality of secondary batteries 400. Positive electrodes of the secondary batteries are in contact with and electrically connected to conductors 424 isolated by an insulator 425. The conductor 424 is electrically connected to a control circuit 420 through a wiring 423. Negative electrodes of the secondary batteries are electrically connected to the control circuit 420 through a wiring 426. As the control circuit 420, a charging and discharging control circuit for performing charging, discharging, and the like or a protection circuit for preventing overcharging or overdischarging can be used.

FIG. 8D illustrates an example of the power storage system 415. The power storage system 415 includes the plurality of secondary batteries 400, and the plurality of secondary batteries 400 are sandwiched between a conductive plate 413 and a conductive plate 414. The plurality of secondary batteries 400 are electrically connected to the conductive plate 413 and the conductive plate 414 through a wiring 416. The plurality of secondary batteries 400 may be connected in parallel, connected in series, or connected in series after being connected in parallel. With the power storage system 415 including the plurality of secondary batteries 400, large electric power can be extracted.

The plurality of secondary batteries 400 may be connected in series after being connected in parallel.

A temperature control device may be provided between the plurality of secondary batteries 400. When the secondary batteries 400 are heated excessively, the temperature control device can cool them, and when the secondary batteries 400 get too cold, the temperature control device can heat them. Thus, the performance of the power storage system 415 is not easily influenced by the outside temperature.

In FIG. 8D, the power storage system 415 is electrically connected to the control circuit 420 through a wiring 421 and a wiring 422. The wiring 421 is electrically connected to the positive electrodes of the plurality of secondary batteries 400 through the conductive plate 413, and the wiring 422 is electrically connected to the negative electrodes of the plurality of secondary batteries 400 through the conductive plate 414.

### [Other Structure Examples of Secondary Battery]

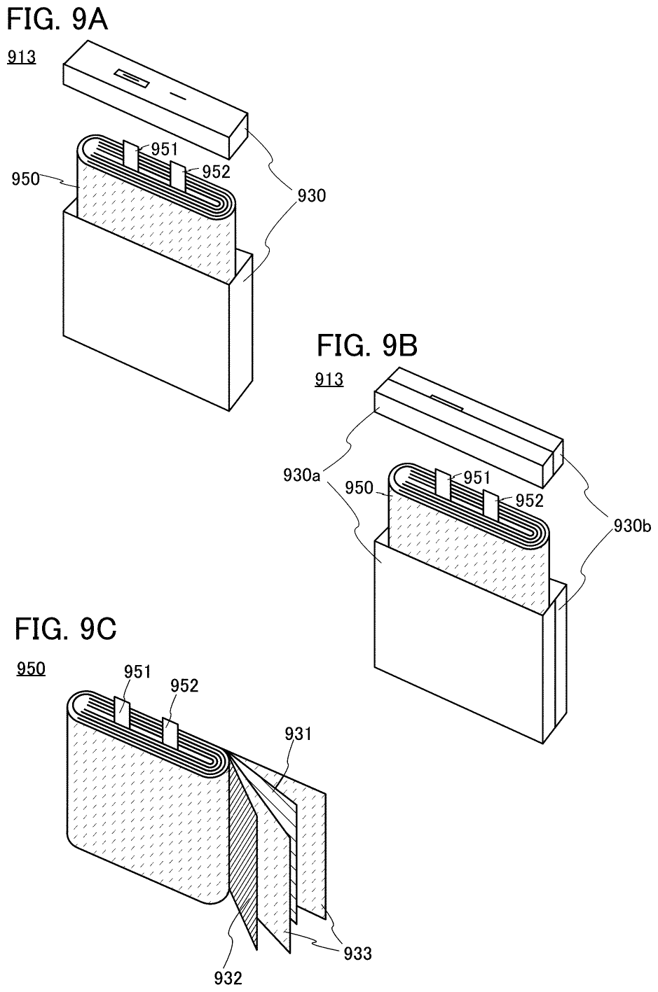

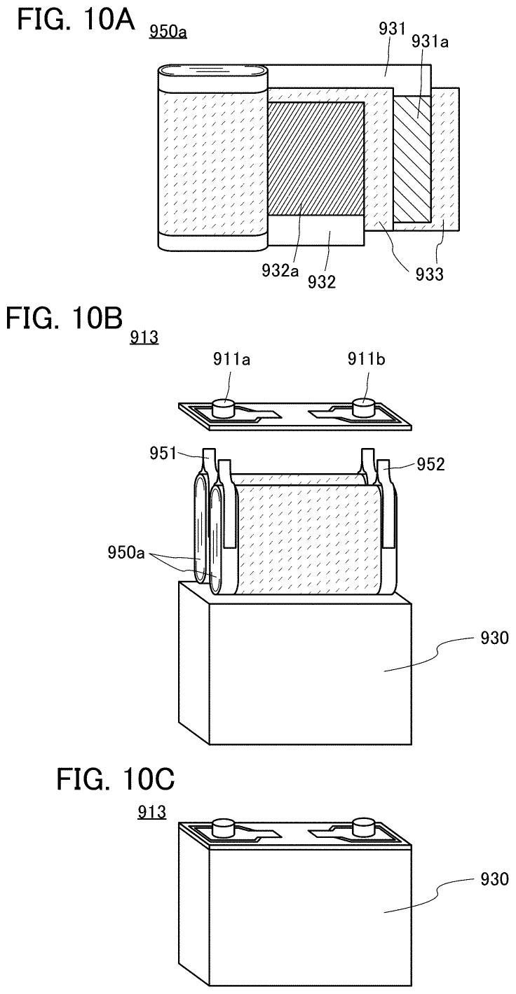

Structure examples of a secondary battery will be described with reference to FIG. 9 and FIG. 10.

The secondary battery 913 illustrated in FIG. 9A includes a wound body 950 provided with a terminal 951 and a terminal 952 inside a housing 930. The wound body 950 is soaked in an electrolyte solution inside the housing 930. The terminal 952 is in contact with the housing 930. The use of an insulator or the like prevents contact between the terminal 951 and the housing 930. Note that in FIG. 9A, the housing 930 divided into pieces is illustrated for convenience; however, in the actual structure, the wound body 950 is covered with the housing 930 and the terminal 951 and the terminal 952 extend to the outside of the housing 930. For the housing 930, a metal material (e.g., aluminum) or a resin material can be used.

Note that as illustrated in FIG. 9B, the housing 930 illustrated in FIG. 9A may be formed using a plurality of materials. For example, in the secondary battery 913 illustrated in FIG. 9B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field from the secondary battery 913 can be inhibited. When an electric field is not significantly blocked by the housing 930a, an antenna may be provided inside the housing 930a. For the housing 930b, a metal material can be used, for example.

FIG. 9C illustrates the structure of the wound body 950. The wound body 950 includes a negative electrode 931, a positive electrode 932, and separators 933. The wound body 950 is obtained by winding a sheet of a stack in which the negative electrode 931 overlaps with the positive electrode 932 with the separator 933 provided therebetween. Note that a plurality of stacks each including the negative electrode 931, the positive electrode 932, and the separator 933 may be further stacked.

As illustrated in FIG. 10, the secondary battery 913 may include a wound body 950a. The wound body 950a illustrated in FIG. 10A includes the negative electrode 931, the positive electrode 932, and the separators 933. The negative electrode 931 includes a negative electrode active material layer 931a. The positive electrode 932 includes a positive electrode active material layer 932a. The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 10B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 10C, the wound body 950a and an electrolyte solution are covered with the housing 930, whereby the secondary battery 913 is obtained. The housing 930 is preferably provided with a safety valve, an overcurrent protection element, and the like. A safety valve is a valve to be released by a predetermined internal pressure of the housing 930 in order to prevent the battery from exploding.

As illustrated in FIG. 10B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 9A to FIG. 9C can be referred to for the other components of the secondary battery 913 illustrated in FIG. 10A and FIG. 10B.

When the positive electrode described in the above embodiment is used as the positive electrode 932, the secondary battery 913 with high charge and discharge capacity and excellent cycle performance can be obtained.

### <Laminated Secondary Battery>

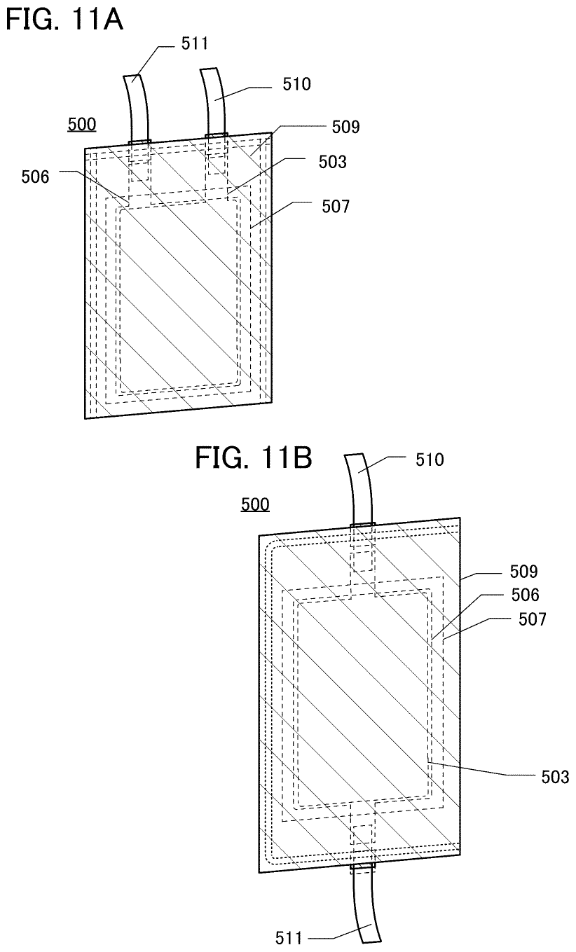

FIG. 11A and FIG. 11B each illustrate an example of an external view of a laminated secondary battery. In FIG. 11A and FIG. 11B, a positive electrode 503, a negative electrode 506, a separator 507, an exterior body 509, a positive electrode lead electrode 510, and a negative electrode lead electrode 511 are included.

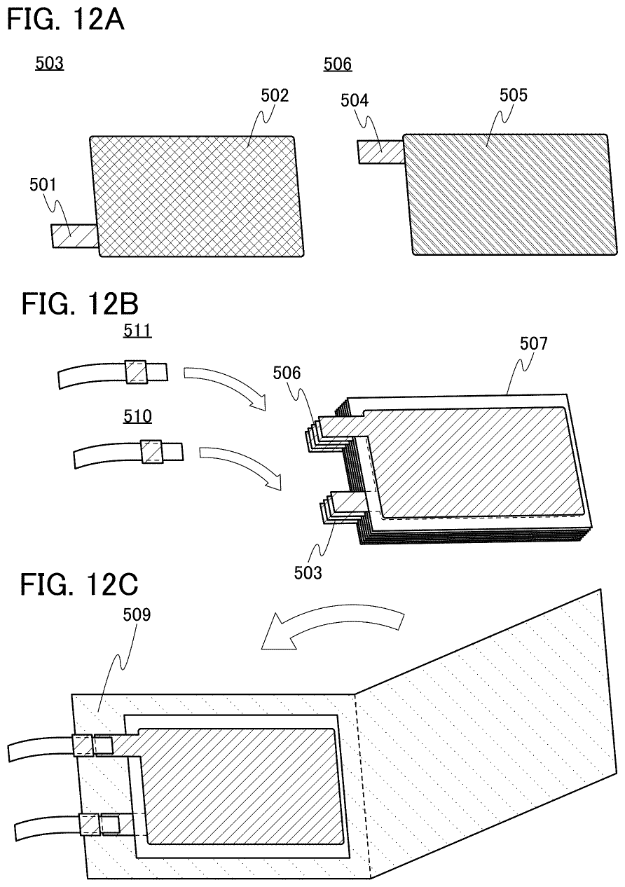

FIG. 12A illustrates external views of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas or the shapes of the tab regions included in the positive electrode and the negative electrode are not limited to the examples illustrated in FIG. 12A.

### <Method for Forming Laminated Secondary Battery>

Here, an example of a method for forming the laminated secondary battery whose external view is illustrated in FIG. 11A is described with reference to FIG. 12B and FIG. 12C.

First, the negative electrode 506, the separator 507, and the positive electrode 503 are stacked. FIG. 12B illustrates a stack including the negative electrode 506, the separator 507, and the positive electrode 503. Here, an example in which 5 negative electrodes and 4 positive electrodes are used is shown. This component can also be referred to as a stack including the negative electrodes, the separators, and the positive electrodes. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

After that, the negative electrode 506, the separator 507, and the positive electrode 503 are placed over the exterior body 509.

Subsequently, the exterior body 509 is folded along a portion shown by a dashed line as illustrated in FIG. 12C. Then, the outer edges of the exterior body 509 are bonded to each other. The bonding can be performed by thermocompression bonding, for example. At this time, an unbonded region (hereinafter, referred to as an inlet) is provided for part (or one side) of the exterior body 509 so that an electrolyte solution can be put later.

Next, an electrolyte solution (not illustrated) is introduced into the exterior body 509 from the inlet of the exterior body 509. The electrolyte solution is preferably introduced in a reduced pressure atmosphere or in an inert atmosphere. Lastly, the inlet is bonded. In the above manner, a laminated secondary battery 500 can be formed.

When the positive electrode described in the above embodiment is used as the positive electrode 503, the secondary battery 500 can have high charge and discharge capacity and can include the positive electrode with a high density.

### [Examples of Battery Pack]

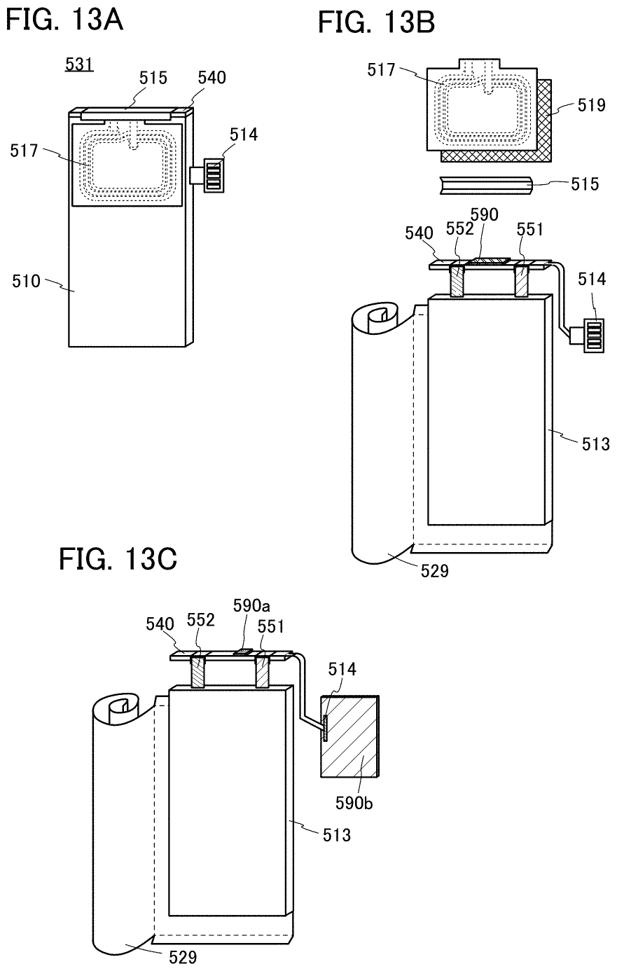

Examples of a secondary battery pack of one embodiment of the present invention that is capable of wireless charging using an antenna will be described with reference to FIG. 13.

FIG. 13A illustrates the appearance of a secondary battery pack 531 that has a rectangular solid shape with a small thickness (also referred to as a flat plate shape with a certain thickness). FIG. 13B illustrates a structure of the secondary battery pack 531. The secondary battery pack 531 includes a circuit board 540 and a secondary battery 513. A label 529 is attached onto the secondary battery 513. The circuit board 540 is fixed by a sealant 515. The secondary battery pack 531 also includes an antenna 517.

The internal structure of the secondary battery 513 may be a structure including a wound body or a structure including a stack.

In the secondary battery pack 531, a control circuit 590 is provided over the circuit board 540 as illustrated in FIG. 13B, for example. The circuit board 540 is electrically connected to a terminal 514. The circuit board 540 is electrically connected to the antenna 517, one 551 of a positive electrode lead and a negative electrode lead of the secondary battery 513, and the other 552 of the positive electrode lead and the negative electrode lead.

Alternatively, as illustrated in FIG. 13C, a circuit system 590a provided over the circuit board 540 and a circuit system 590b electrically connected to the circuit board 540 through the terminal 514 may be included. For example, a part of the control circuit is provided in the circuit system 590a, and another part thereof is provided in the circuit system 590b.

Note that the shape of the antenna 517 is not limited to a coil shape and may be a linear shape or a plate shape, for example. An antenna such as a planar antenna, an aperture antenna, a traveling-wave antenna, an EH antenna, a magnetic-field antenna, or a dielectric antenna may be used. Alternatively, the antenna 517 may be a flat-plate conductor. This flat-plate conductor can serve as one of conductors for electric field coupling. That is, the antenna 517 may serve as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. For the layer 519, a magnetic material can be used, for instance.

This embodiment can be freely combined with the other embodiments.

### Embodiment 4

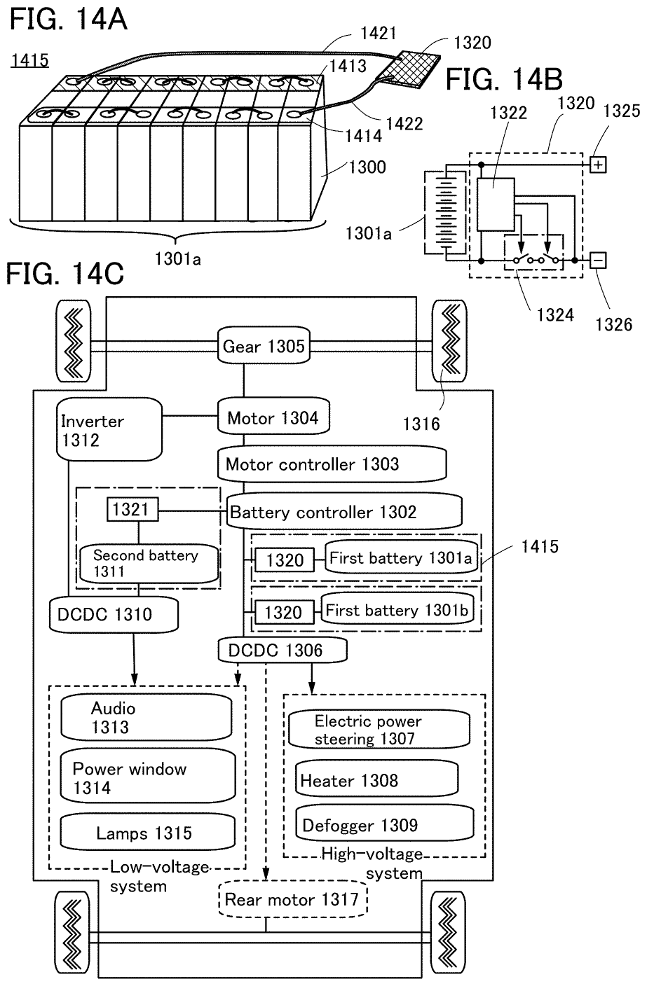

An example that is different from the cylindrical secondary battery in FIG. 8D is described in this embodiment. An application example of the secondary battery in an electric vehicle (EV) is described with reference to FIG. 14C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (a starter battery). The second battery 1311 specifically needs high output and does not necessarily have high capacity, and the capacity of the second battery 1311 is lower than that of the first batteries 1301a and 1301b.

The internal structure of the first battery 1301a may be the wound structure illustrated in FIG. 9A, FIG. 9B, FIG. 9C, or FIG. 10A or the stacked structure illustrated in FIG. 11A, FIG. 11B, FIG. 12A, FIG. 12B, or FIG. 12C.

Although this embodiment shows an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. A plurality of secondary batteries are also referred to as an assembled battery.

An in-vehicle secondary battery includes a service plug or a circuit breaker that can cut off high voltage without the use of equipment in order to cut off electric power from a plurality of secondary batteries and is provided in the first battery 1301a.

Electric power from the first batteries 1301a and 1301b is mainly used to rotate the motor 1304 and is also supplied to in-vehicle parts for 42 V (such as an electric power steering 1307, a heater 1308, and a defogger 1309) through a DCDC circuit 1306. In the case where there is a rear motor 1317 for the rear wheels, the first battery 1301a is used to rotate the rear motor 1317.

The second battery 1311 supplies electric power to in-vehicle parts for 14 V (such as an audio 1313, power windows 1314, and lamps 1315) through a DCDC circuit 1310.

The first battery 1301a is described with reference to FIG. 14A.

FIG. 14A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment shows an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414, a battery container box, or the like. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charging control circuit or a battery control system that includes a memory circuit including a transistor using an oxide semiconductor may be referred to as a BTOS (Battery operating system or Battery oxide semiconductor).

A metal oxide functioning as an oxide semiconductor is preferably used. For example, as the oxide, a metal oxide such as an In-M-Zn oxide (the element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In-M-Zn oxide that can be used as the oxide is preferably a CAAC-OS (C-Axis Aligned Crystal Oxide Semiconductor) or a CAC-OS (Cloud-Aligned Composite Oxide Semiconductor). Furthermore, as the oxide, an In—Ga oxide or an In—Zn oxide may be used. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. When an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the direction of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. The CAC-OS has, for example, a composition in which elements included in a metal oxide are unevenly distributed. Materials including unevenly distributed elements each have a size greater than or equal to 0.5 nm and less than or equal to 10 nm, preferably greater than or equal to 1 nm and less than or equal to 3 nm, or a similar size. Note that in the following description of a metal oxide, a state in which one or more metal elements are unevenly distributed and regions including the metal element(s) are mixed is referred to as a mosaic pattern or a patch-like pattern. The regions each have a size greater than or equal to 0.5 nm and less than or equal to 10 nm, preferably greater than or equal to 1 nm and less than or equal to 3 nm, or a similar size.

In addition, the CAC-OS has a composition in which materials are separated into a first region and a second region to form a mosaic pattern, and the first regions are distributed in the film (this composition is hereinafter also referred to as a cloud-like composition). That is, the CAC-OS is a composite metal oxide having a composition in which the first regions and the second regions are mixed.

Note that the atomic ratios of In, Ga, and Zn to the metal elements contained in the CAC-OS in an In—Ga—Zn oxide are denoted with [In], [Ga], and [Zn], respectively. For example, the first region in the CAC-OS in the In—Ga—Zn oxide has [In] higher than that in the composition of the CAC-OS film. Moreover, the second region has [Ga] higher than that in the composition of the CAC-OS film. For example, the first region has higher [In] and lower [Ga] than the second region. Moreover, the second region has higher [Ga] and lower [In] than the first region.

Specifically, the first region includes indium oxide, indium zinc oxide, or the like as its main component. The second region includes gallium oxide, gallium zinc oxide, or the like as its main component. That is, the first region can be referred to as a region containing In as its main component. The second region can be referred to as a region containing Ga as its main component.

Note that a clear boundary between the first region and the second region cannot be observed in some cases.

For example, energy dispersive X-ray spectroscopy (EDX) is used to obtain EDX mapping, and according to the EDX mapping, the CAC-OS in the In—Ga—Zn oxide has a structure in which the region containing In as its main component (the first region) and the region containing Ga as its main component (the second region) are unevenly distributed and mixed.

In the case where the CAC-OS is used for a transistor, a switching function (on/off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Accordingly, when the CAC-OS is used for a transistor, high on-state current (Iₒₙ), high field-effect mobility (μ), and excellent switching operation can be achieved.

An oxide semiconductor has various structures with different properties. Two or more kinds among an amorphous oxide semiconductor, a polycrystalline oxide semiconductor, an a-like OS, the CAC-OS, an nc-OS, and the CAAC-OS may be included in an oxide semiconductor of one embodiment of the present invention.

The control circuit portion 1320 can be regarded as detecting a terminal voltage of the secondary battery and controlling the charging and discharging state of the secondary battery. For example, to prevent overcharging, an output transistor of a charging circuit and an interruption switch can be turned off substantially at the same time.

FIG. 14B illustrates an example of a block diagram of the battery pack 1415 illustrated in FIG. 14A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery to be used, and imposes the upper limit of current from the outside, the upper limit of output current to the outside, or the like. The range from the lower limit voltage to the upper limit voltage of the secondary battery falls within the recommended voltage range, and when a voltage falls outside the range, the switch portion 1324 operates and functions as a protection circuit. The control circuit portion 1320 can also be referred to as a protection circuit because it controls the switch portion 1324 to prevent overdischarging or overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charging and discharging path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to a switch including a Si transistor using single crystal silicon; the switch portion 1324 may be formed using a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide, where x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using OS transistors can be stacked over the switch portion 1324 so that they can be integrated into one chip. Since the area occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead batteries are usually used for the second battery 1311 due to cost advantage. When the second battery 1311 that starts the inverter becomes inoperative, the motor cannot be started even when the first batteries 1301a and 1301b have remaining capacity; thus, in order to prevent this, in the case where the second battery 1311 is a lead battery, the second battery is supplied with electric power from the first batteries to constantly maintain a fully-charged state.

In this embodiment, an example in which a lithium-ion secondary battery is used as both the first battery 1301a and the second battery 1311 is described. As the second battery 1311, a lead battery, an all-solid-state battery, or an electric double layer capacitor may be used.

Regenerative energy generated by rolling of tires 1316 is transmitted to the motor 1304 through a gear 1305, and is stored in the second battery 1311 from a motor controller 1303 or a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of fast charging.

The battery controller 1302 can set the charging voltage, charging current, and the like of the first batteries 1301a and 1301b. The battery controller 1302 can set charging conditions in accordance with charging performance of a secondary battery to be used, so that fast charging can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charging stations and the like have a 100 V outlet, a 200 V outlet, or a three-phase 200V outlet with 50 kW, for example. Furthermore, charging can be performed by electric power supplied from external charging equipment with a contactless power feeding method or the like.

For fast charging, secondary batteries that can withstand charging at a high voltage have been desired to perform charging in a short time.

Using both graphene and acetylene black as the conductive additives and optimizing the compounding ratio enable fast charging of the secondary battery in this embodiment. Regenerative charging can be efficiently performed and charging time can be shortened.

Specifically, using both graphene and acetylene black as the conductive additives and optimizing the compounding ratio enable fast charging of the secondary battery in this embodiment at low temperatures (higher than or equal to −40° C. and lower than or equal to 10° C.).

Using both graphene and acetylene black as the conductive additives and optimizing the compounding ratio enable the secondary battery in this embodiment to include a high-density positive electrode. Furthermore, a secondary battery that can inhibit a capacity decrease and keep high capacity can be obtained even when the thickness of an electrode layer and the carried amount increase. This secondary battery is especially effective in a vehicle and can achieve a vehicle that has a high mileage, specifically a driving range per charge of 500 km or longer, without increasing the proportion of the weight of the secondary batteries to the weight of the entire vehicle.

Specifically, in the secondary battery in this embodiment, the use of both graphene and acetylene black as the conductive additives and the optimization of the compounding ratio can increase the operating voltage of the secondary battery, and the increase in charging voltage increases the available capacity.

Next, examples in which the secondary battery of one embodiment of the present invention is mounted on a vehicle, typically a transport vehicle, will be described.

Mounting the secondary battery illustrated in any one of FIG. 8D, FIG. 10C, and FIG. 14A on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can have high capacity. Thus, the secondary battery of one embodiment of the present invention is suitable for reduction in size and weight and is preferably used in transport vehicles.

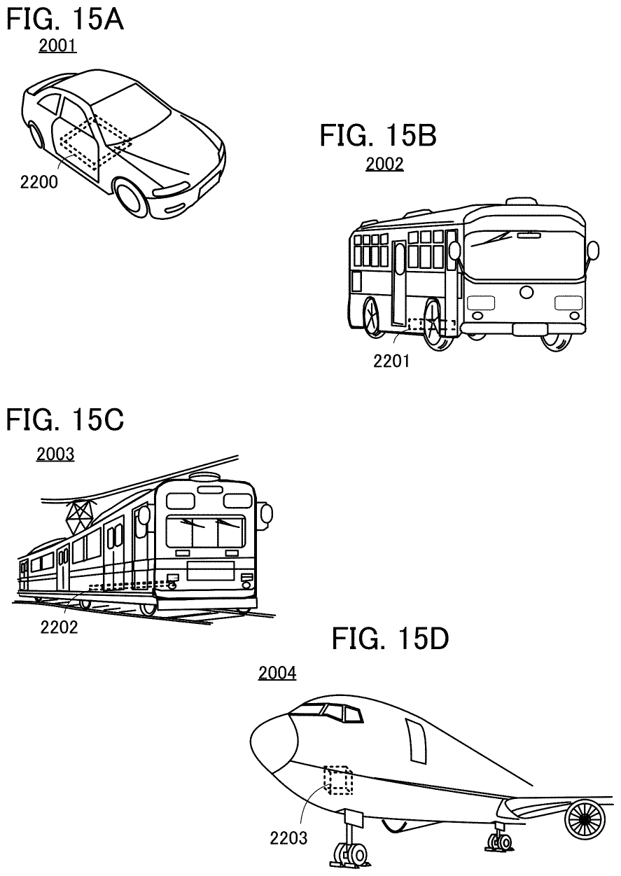

FIG. 15A to FIG. 15D illustrate examples of transport vehicles using one embodiment of the present invention. An automobile 2001 illustrated in FIG. 15A is an electric vehicle that runs on an electric motor as a power source. Alternatively, the automobile 2001 is a hybrid electric vehicle that can appropriately select an electric motor or an engine as a driving power source. In the case where the secondary battery is mounted on the vehicle, the secondary battery exemplified in Embodiment 3 is provided at one position or several positions. The automobile 2001 illustrated in FIG. 15A includes a battery pack 2200, and the battery pack includes a secondary battery module in which a plurality of secondary batteries are connected to each other. Moreover, a charging control device that is electrically connected to the secondary battery module is preferably included.

The automobile 2001 can be charged when the secondary battery included in the automobile 2001 is supplied with electric power through external charging equipment by a plug-in system, a contactless power feeding system, or the like. In charging, a given method such as CHAdeMO (registered trademark) or Combined Charging System can be employed as a charging method, the standard of a connector, or the like as appropriate. The secondary battery may be a charging station provided in a commerce facility or a power source in a house. For example, with the use of the plug-in technique, the secondary battery mounted on the automobile 2001 can be charged by being supplied with electric power from outside. The charging can be performed by converting AC electric power into DC electric power through a converter such as an ACDC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 15B illustrates a large transporter 2002 having a motor controlled by electricity as an example of a transport vehicle. A secondary battery module of the transporter 2002 includes a cell unit of four secondary batteries with 3.5 V or higher and 4.7 V or lower, for example, and 48 cells are connected in series to have a maximum voltage of 170 V. A battery pack 2201 has the same function as that in FIG. 15A except, for example, the number of secondary batteries configuring the secondary battery module; thus, the description is omitted.

FIG. 15C illustrates a large transportation vehicle 2003 having a motor controlled by electricity as an example. The secondary battery module of the transportation vehicle 2003 has 100 or more secondary batteries with 3.5 V or higher and 4.7 V or lower connected in series, and the maximum voltage is 600 V, for example. Thus, the secondary batteries are required to have a small variation in the characteristics. Optimizing the mixing ratio of carbon black to graphene enables the uniformity of the electrodes to increase and secondary batteries with stable battery performance to be formed; thus, low-cost mass production is possible in light of the yield. A battery pack 2202 has the same function as that in FIG. 15A except, for example, the number of secondary batteries configuring the secondary battery module; thus, the description is omitted.

FIG. 15D illustrates an aircraft 2004 having a combustion engine as an example. The aircraft 2004 illustrated in FIG. 15D is regarded as a kind of transport vehicles because it has wheels for takeoff and landing, and includes a battery pack 2203 that includes a charging control device and a secondary battery module configured by connecting a plurality of secondary batteries.

The secondary battery module of the aircraft 2004 has eight 4 V secondary batteries connected in series and has a maximum voltage of 32 V, for example. The battery pack 2203 has the same function as that in FIG. 15A except, for example, the number of secondary batteries configuring the secondary battery module; thus, the description is omitted.

This embodiment can be used in appropriate combination with the other embodiments.

### Embodiment 5

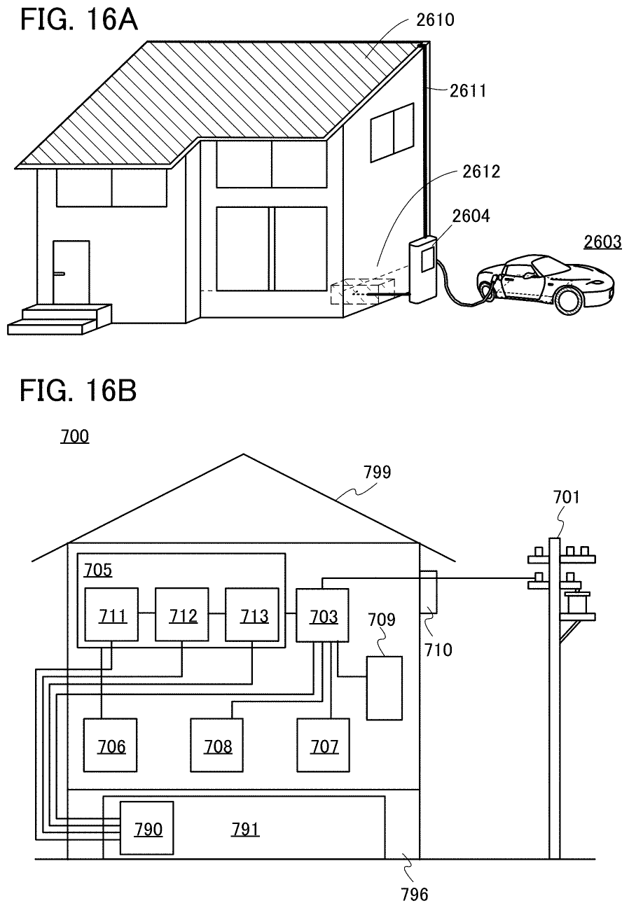

In this embodiment, examples in which the secondary battery of one embodiment of the present invention is mounted on a building will be described with reference to FIG. 16A and FIG. 16B.

A house illustrated in FIG. 16A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to ground-based charging equipment 2604. The power storage device 2612 can be charged with electric power generated by the solar panel 2610. The secondary battery included in a vehicle 2603 can be charged with the electric power stored in the power storage device 2612 through the charging equipment 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure or the like.

FIG. 16B illustrates an example of a power storage device 700 of one embodiment of the present invention. As illustrated in FIG. 16B, a power storage device 791 of one embodiment of the present invention is provided in an underfloor space 796 of a building 799.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave oven, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charging and discharging plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electric device such as a TV or a personal computer through the router 709. Furthermore, it can be checked with a portable electronic terminal such as a smartphone or a tablet through the router 709. With the indicator 706, the electric device, or the portable electronic terminal, for example, the demand for electric power depending on a time period (or per hour) that is predicted by the predicting portion 712 can be checked.

This embodiment can be used in appropriate combination with the other embodiments.

### Embodiment 6

This embodiment will describe examples in which the power storage device of one embodiment of the present invention is mounted on a motorcycle and a bicycle.

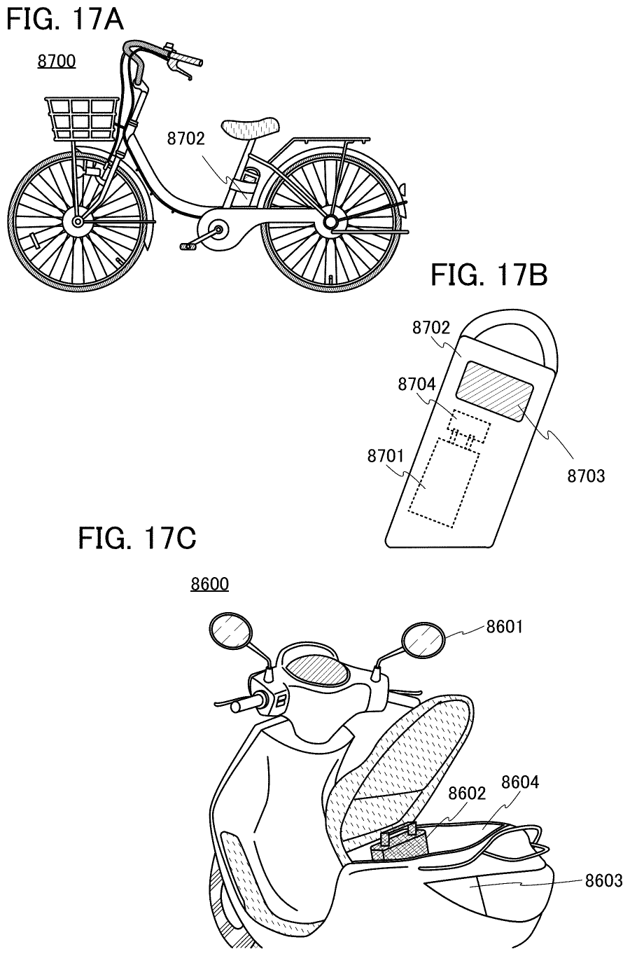

FIG. 17A illustrates an example of an electric bicycle using the power storage device of one embodiment of the present invention. The power storage device of one embodiment of the present invention can be used for an electric bicycle 8700 illustrated in FIG. 17A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 17B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 also includes a control circuit 8704 of one embodiment of the present invention. The control circuit 8704 is electrically connected to a positive electrode and a negative electrode of the storage battery 8701.

FIG. 17C illustrates an example of a motorcycle using the power storage device of one embodiment of the present invention. A motor scooter 8600 illustrated in FIG. 17C includes a power storage device 8602, side mirrors 8601, and indicator lights 8603. The power storage device 8602 can supply electricity to the indicator lights 8603.

In the motor scooter 8600 illustrated in FIG. 17C, the power storage device 8602 can be stored in an under-seat storage unit 8604. The power storage device 8602 can be stored in the under-seat storage unit 8604 even with a small size.

### Embodiment 7

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a notebook personal computer, a tablet terminal, and a mobile phone.

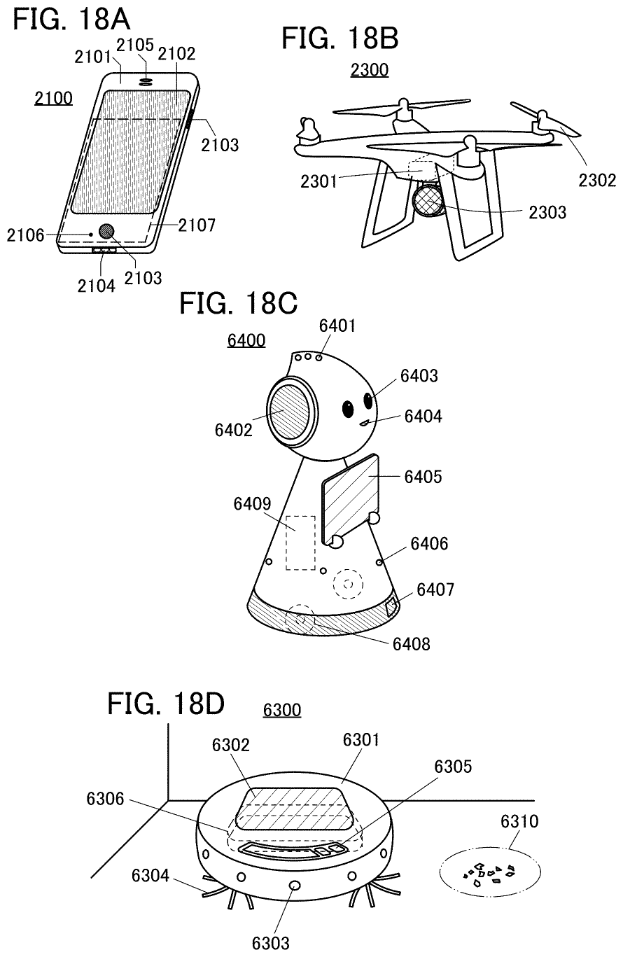

FIG. 18A illustrates an example of a mobile phone. A mobile phone 2100 includes a housing 2101 in which a display portion 2102 is incorporated, an operation button 2103, an external connection port 2104, a speaker 2105, a microphone 2106, and the like. Note that the mobile phone 2100 includes a secondary battery 2107.

The mobile phone 2100 is capable of executing a variety of applications such as mobile phone calls, e-mailing, viewing and editing texts, music reproduction, Internet communication, and computer games.

With the operation button 2103, a variety of functions such as time setting, power on/off operation, wireless communication on/off operation, execution and cancellation of a silent mode, and execution and cancellation of a power saving mode can be performed. For example, the functions of the operation button 2103 can also be set freely by an operating system incorporated in the mobile phone 2100.

In addition, the mobile phone 2100 can execute near field communication conformable to a communication standard. For example, mutual communication between the mobile phone 2100 and a headset capable of wireless communication enables hands-free calling.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 18B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. The secondary battery of one embodiment of the present invention is preferable as a secondary battery mounted on the unmanned aircraft 2300 because it has a high level of safety and thus can be used safely for a long time over a long period.

FIG. 18C illustrates an example of a robot. A robot 6400 illustrated in FIG. 18C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes the secondary battery 6409 of one embodiment of the present invention and a semiconductor device or an electronic component in its interior region. The robot 6400 including the secondary battery of one embodiment of the present invention can be a highly reliable electronic device that can operate for a long time.

FIG. 18D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes the secondary battery 6306 of one embodiment of the present invention and a semiconductor device or an electronic component in its interior region. The cleaning robot 6300 including the secondary battery 6306 of one embodiment of the present invention can be a highly reliable electronic device that can operate for a long time.

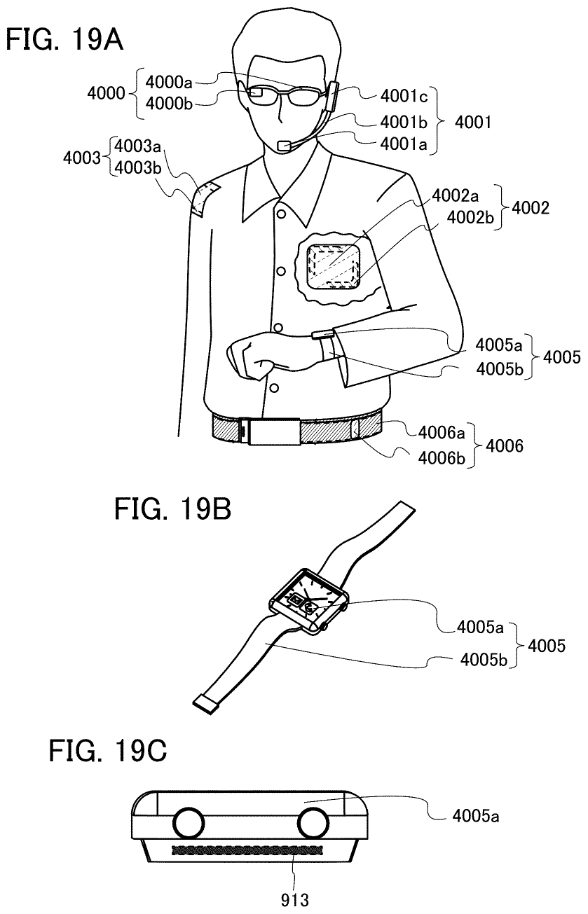

FIG. 19A illustrates examples of wearable devices. A secondary battery is used as a power source of a wearable device. To have improved water resistance in indoor use or outdoor use by a user, a wearable device is desirably capable of being charged wirelessly as well as being charged with a wire whose connector portion for connection is exposed.

For example, the secondary battery of one embodiment of the present invention can be provided in a glasses-type device 4000 illustrated in FIG. 19A. The glasses-type device 4000 includes a frame 4000a and a display portion 4000b. The secondary battery is provided in a temple of the frame 4000a having a curved shape, whereby the glasses-type device 4000 can be lightweight, can have a well-balanced weight, and can be used continuously for a long time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b or the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, the density and the capacity can be high and space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided in a region inside the belt portion 4006a. With the use of the secondary battery of one embodiment of the present invention, the density and the capacity can be high and space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, the density and the capacity can be high and space saving required with downsizing of a housing can be achieved.

The display portion 4005a can display various kinds of information such as time and reception information of an e-mail or an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 19B is a perspective view of the watch-type device 4005 that is detached from an arm.

FIG. 19C is a side view. FIG. 19C illustrates a state where the secondary battery 913 is incorporated in an interior region. The secondary battery 913 is the secondary battery described in Embodiment 3. The secondary battery 913, which can have a high density and high capacity and is small and lightweight, overlaps with the display portion 4005a.

This embodiment can be used in appropriate combination with the other embodiments.

### Example 1

In this example, a positive electrode was formed using both graphene and acetylene black as conductive additives, and its cross-sectional SEM image was captured.

First, an active material, acetylene black, graphene, PVDF, and NMP were prepared and weighed to be desired amounts.

In this example, a lithium composite oxide in which a ratio of Ni to Co and Mn is 8:1:1 was used as the active material.

As Sample 1, an electrode in which the active material, graphene, acetylene black, and PVDF were compounded at a weight ratio of 95:0.6:2.4:2 was used.

As Sample 2, an electrode in which the active material, graphene, acetylene black, and

PVDF were compounded at a weight ratio of 95:0.9:2.1:2 was used.

As Sample 3, an electrode in which the active material, graphene, acetylene black, and PVDF were compounded at a weight ratio of 95:1.5:1.5:2 was used. Sample 3 is one of comparative examples in which the weight ratio of graphene to acetylene black is 1:1 because they have the same weight.

As Comparative example 1, an electrode in which the active material, acetylene black, and PVDF were compounded at a weight ratio of 95:3:2 was used.

As Comparative example 2, an electrode in which the active material, graphene, and PVDF were compounded at a weight ratio of 95:3:2 was used.

Each of the electrodes was formed by the formation method in which an electrode slurry was formed in accordance with the flowchart in FIG. 4 and the electrode slurry was applied to a 20-μm-thick current collector (aluminum) and then dried.

In the case of performing kneading, mixing is performed with Awatori Rentaro (product name, ARE-310, produced by THINKY CORPORATION). The mixer is not limited to Awatori Rentaro.

Then, pressing was performed, followed by punching to form the positive electrode. Note that the pressing was performed under eight different conditions in the range of the press line pressure of higher than or equal to 84 kN/m and lower than or equal to 1467 kN/m.

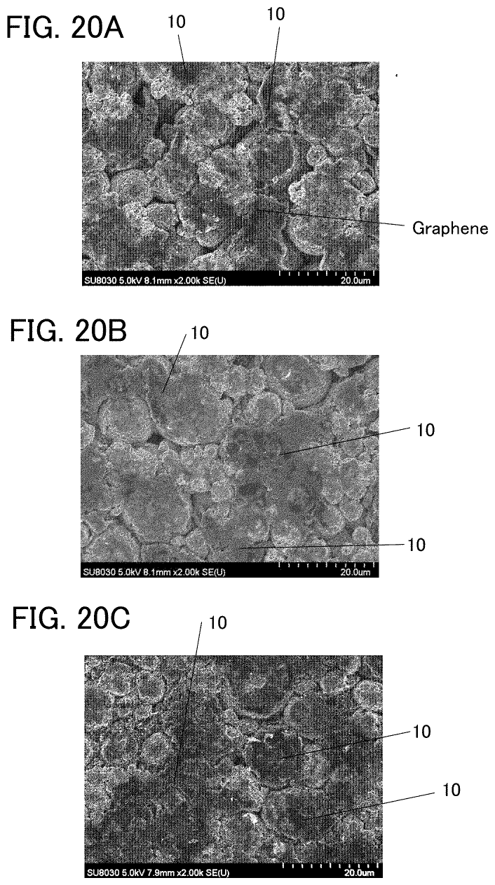

FIG. 20A is a cross-sectional SEM image of Sample 1. The number of observed aggregated portions of acetylene black and graphene was comparatively small. The carried amount of Sample 1 was 20.35 mg/cm². With a press line pressure of 1467 kN/m, the total thickness of the electrode layer and the current collector was 76.5 μm and the density was 3.79 g/cc. With a press line pressure of 700 kN/m or higher, the density can be approximately higher than 3.5 g/cc. Note that the press line pressure (also simply referred to as line pressure) is an indicator showing formation pressure per unit length of a roll in the width direction subjected to the pressing.

FIG. 20B is a cross-sectional SEM image of Sample 2. The number of observed aggregated portions of acetylene black and graphene was larger than that in FIG. 20A. The carried amount of Sample 2 was 20.07 mg/cm².

FIG. 20C is a cross-sectional SEM image of Sample 3. A large number of aggregates were observed in FIG. 20C. The carried amount of Sample 3 was 19.82 mg/cm².

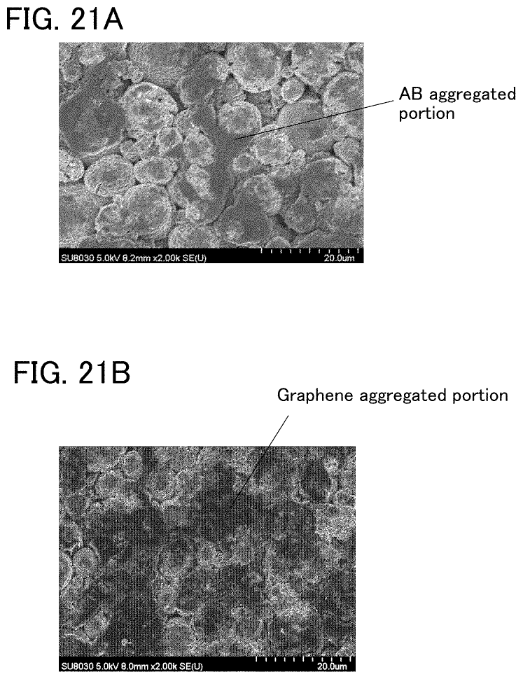

FIG. 21A is a cross-sectional SEM image of Comparative example 1. The number of observed aggregated portions of acetylene black was comparatively large in FIG. 21A. The carried amount of Comparative example 1 was 18.48 mg/cm².

FIG. 21B is a cross-sectional SEM image of Comparative example 2. The number of observed aggregated portions of graphene was comparatively large in FIG. 21B. The carried amount of Comparative example 2 was 18.46 mg/cm².

These results demonstrate that Samples 1 and 2 using both graphene and acetylene black have a comparatively small number of aggregated portions and can be electrodes with high densities as compared with the other samples. Furthermore, a secondary battery that can inhibit a capacity decrease and keep high capacity can be obtained even when the thickness of an electrode layer and the carried amount increase. This secondary battery is especially effectively used in a vehicle.

### REFERENCE NUMERALS

10: aggregated portion, 11: void, 101: mixture, 102: mixture, 103: mixture, 104: mixture, 114: memory element, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 400: secondary battery, 401: positive electrode cap, 413: conductive plate, 414: conductive plate, 415: power storage system, 416: wiring, 420: control circuit, 421: wiring, 422: wiring, 423: wiring, 424: conductor, 425: insulator, 426: wiring, 500: secondary battery, 501: positive electrode current collector, 502: positive electrode active material layer, 503: positive electrode, 504: negative electrode current collector, 505: negative electrode active material layer, 506: negative electrode, 507: separator, 509: exterior body, 510: positive electrode lead electrode, 511: negative electrode lead electrode, 513: secondary battery, 514: terminal, 515: sealant, 517: antenna, 519: layer, 529: label, 531: secondary battery pack, 540: circuit board, 551: one of positive electrode lead and negative electrode lead, 552: the other of positive electrode lead and negative electrode lead, 590: control circuit, 590a: circuit system, 590b: circuit system, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 613: safety valve mechanism, 700: power storage device, 701: commercial power source, 703: distribution board, 705: power storage controller, 706: indicator, 707: general load, 708: power storage load, 709: router, 710: service wire mounting portion, 711: measuring portion, 712: predicting portion, 713: planning portion, 790: control device, 791: power storage device, 796: underfloor space, 799: building, 911a: terminal, 911b: terminal, 913: secondary battery, 930: housing, 930a: housing, 930b: housing, 931: negative electrode, 931a: negative electrode active material layer, 932: positive electrode, 932a: positive electrode active material layer, 933: separator, 950: wound body, 950a: wound body, 951: terminal, 952: terminal, 1300: rectangular secondary battery, 1301a: battery, 1301b: battery, 1302: battery controller, 1303: motor controller, 1304: motor, 1305: gear, 1306: DCDC circuit, 1307: electric power steering, 1308: heater, 1309: defogger, 1310: DCDC circuit, 1311: battery, 1312: inverter, 1313: audio, 1314: power window, 1315: lamps, 1316: tire, 1317: rear motor, 1320: control circuit portion, 1321: control circuit portion, 1322: control circuit, 1324: switch portion, 1325: external terminal, 1326: external terminal, 1413: fixing portion, 1414: fixing portion, 1415: battery pack, 1421: wiring, 1422: wiring, 2001: automobile, 2002: transporter, 2003: transportation vehicle, 2004: aircraft, 2100: mobile phone, 2101: housing, 2102: display portion, 2103: operation button, 2104: external connection port, 2105: speaker, 2106: microphone, 2107: secondary battery, 2200: battery pack, 2201: battery pack, 2202: battery pack, 2203: battery pack, 2300: unmanned aircraft, 2301: secondary battery, 2302: rotor, 2303: camera, 2603: vehicle, 2604: charging equipment, 2610: solar panel, 2611: wiring, 2612: power storage device, 4000: glasses-type device, 4000a: frame, 4000b: display portion, 4001: headset-type device, 4001a: microphone portion, 4001b: flexible pipe, 4001c: earphone portion, 4002: device, 4002a: housing, 4002b: secondary battery, 4003: device, 4003a: housing, 4003b: secondary battery, 4005: watch-type device, 4005a: display portion, 4005b: belt portion, 4006: belt-type device, 4006a: belt portion, 4006b: wireless power feeding and receiving portion, 6300: cleaning robot, 6301: housing, 6302: display portion, 6303: camera, 6304: brush, 6305: operation button, 6306: secondary battery, 6310: dust, 6400: robot, 6401: illuminance sensor, 6402: microphone, 6403: upper camera, 6404: speaker, 6405: display portion, 6406: lower camera, 6407: obstacle sensor, 6408: moving mechanism, 6409: secondary battery, 8600: motor scooter, 8601: side mirror, 8602: power storage device, 8603: indicator light, 8604: under-seat storage unit, 8700: electric bicycle, 8701: storage battery, 8702: power storage device, 8703: display portion, 8704: control circuit

1. A method for forming a secondary battery, comprising:
a first step of mixing graphene, carbon black, and a binder to obtain a first mixture;
a second step of mixing the first mixture with a positive electrode active material to obtain a second mixture;
a third step of mixing the second mixture with a dispersion medium to obtain an electrode slurry;
a fourth step of applying the electrode slurry to a positive electrode current collector;
a fifth step of drying the electrode slurry to form a positive electrode; and
a sixth step of overlapping the positive electrode and a negative electrode to form a secondary battery,
wherein a weight of the carbon black is more than or equal to 1.5 times and less than or equal to 20 times a weight of the graphene in the mixing in the first step.

2. The method for forming a secondary battery according to claim 1,
wherein pressing is performed after the fifth step at a press line pressure of higher than or equal to 700 kN/m.

3. The method for forming a secondary battery according to claim 1,
wherein the positive electrode active material comprises at least lithium and cobalt.

4. The method for forming a secondary battery according to claim 3,
wherein the positive electrode active material further comprises nickel.

5. The method for forming a secondary battery according to claim 4,
wherein the positive electrode active material further comprises manganese.

6. The method for forming a secondary battery according to claim 4,
wherein the positive electrode active material further comprises aluminum.

7. The method for forming a secondary battery according to claim 3,
wherein the positive electrode active material comprises fluorine in a surface portion.

8. A secondary battery comprising:
a positive electrode active material comprising lithium and cobalt;
a positive electrode active material layer comprising a first carbon material, a second carbon material, and a resin; and
a negative electrode active material layer overlapping with the positive electrode active material layer,
wherein a weight of the second carbon material is more than or equal to 1.5 times and less than or equal to 20 times a weight of the first carbon material.

9. The secondary battery according to claim 8,
wherein the positive electrode active material layer comprises an aggregated portion, and
wherein a percentage of the aggregated portion in the positive electrode active material layer obtained by image analysis is less than 14%.

10. A secondary battery comprising:
a positive electrode active material comprising lithium and cobalt;
a positive electrode active material layer comprising a first carbon material, a second carbon material, and a resin; and
a negative electrode active material layer overlapping with the positive electrode active material layer,
wherein a percentage of an aggregated portion in the positive electrode active material layer obtained by image analysis is less than 14%.

11. (canceled)

12. The secondary battery according to claim 8,
wherein the first carbon material is single-layer graphene or multilayer graphene, and
wherein the second carbon material is carbon black.

13. The secondary battery according to claim 12, wherein the resin is polyvinylidene fluoride.

14. The secondary battery according to claim 8, comprising an electrolyte solution.

15. The secondary battery according to claim 8, comprising a solid electrolyte.

16. The secondary battery according to claim 10, wherein porosity of the positive electrode active material layer obtained by the image analysis is higher than or equal to 3.4% and lower than or equal to 7%.

17. The secondary battery according to claim 8, wherein a density of the positive electrode active material layer measured by gravimetry is higher than 3.5 g/cc.

18. The secondary battery according to claim 10, wherein the aggregated portion in the positive electrode active material layer is a region where a profile indicating graphene or a profile indicating carbon black is measured by X-ray diffraction.

19. The secondary battery according to claim 10, wherein the aggregated portion in the positive electrode active material layer is a region where a peak indicating graphene or a peak indicating carbon black is measured by Raman spectroscopy.

20. The secondary battery according to claim 8, wherein the positive electrode active material further comprises nickel.

21. The secondary battery according to claim 20, wherein the positive electrode active material further comprises manganese.

22. The secondary battery according to claim 20, wherein the positive electrode active material further comprises aluminum.

23. The secondary battery according to claim 20, wherein the positive electrode active material further comprises titanium.

24. The secondary battery according to claim 20, wherein the positive electrode active material comprises fluorine in a surface portion.

25. A vehicle comprising the secondary battery according to claim 8.
